(19) United States
(12) Patent Application Publication
(10) Pub. No.: US 2013/0291029 A1
(43) Pub. Date: Oct. 31, 2013

(54) CABLE TELEVISION CABLE TAP DEVICE

(71) Applicant: PPC Broadband, Inc., East Syracuse, NY (US)

(72) Inventor: Chad T. Wells, Centennial, CO (US)

(21) Appl. No.: 13/926,554

(22) Filed: Jun. 25, 2013

Related U.S. Application Data
(63) Continuation-in-part of application No. 13/688,420, filed on Nov. 29, 2012.
Application No. 13/688,420 is a continuation of application No. 12/563,719, filed on Sep. 21, 2009, now Pat. No. 8,356,322.

(51) Int. Cl. H04N 21/61

(52) U.S. Cl. CPC H04N 21/6168
USPC 725/78

(57) ABSTRACT

A cable television (CATV) cable tap device is disclosed. The cable tap device is part of a cable network which distributes upstream and downstream CATV signals between a cable television headend and one or more subscriber premises. The cable tap device includes a signal splitting device which taps off a portion of the CATV signals incident at the cable tap device entry port to a tap port of the cable tap device. The cable tap device includes a CATV signal conditioning circuit. The CATV signal conditioning circuit can include an in-home entertainment signal frequency rejection device, which prevents in-home entertainment signals from being conducted through the cable tap device to the headend. In some embodiments the cable tap device includes an ingress noise mitigation circuit, which mitigates ingress noise in the upstream CATV signals.

### CROSS-REFERENCE TO RELATED APPLICATIONS

This application is a continuation-in-part of U.S. patent application Ser. No. 13/688,420 filed Nov. 29, 2012 by Chad T. Wells and John M. Egan Jr. and entitled “Passive Multi-Port Entry Adapter and Method for Preserving Downstream CATV Signal Strength within In-Home Network”, which is in turn a continuation of U.S. patent application Ser. No. 12/563,719 filed Sep. 21, 2009 by Chad T. Wells and John M. Egan Jr. and entitled “Passive Multi-Port Entry Adapter and Method for Preserving Downstream CATV Signal Strength within In-Home Network”, which applications are incorporated herein by reference in their entirety. This application is related to U.S. patent application Ser. No. 12/250,229 filed Oct. 13, 2008 by Charles F. Newby, Gregory F. Halik, and Matthew Kellog and entitled “Ingress Noise Inhibiting Network Interface Device and Method for Cable Television Networks”, which is incorporated herein by reference in its entirety.

### FIELD OF THE INVENTION

This invention relates to cable television (CATV) networks and to in-home entertainment (IHE) networks which share existing coaxial cables within a subscriber premises for distribution of CATV and in-home entertainment communication signals. More particularly, the present invention relates to a cable tap device which splits off a portion of CATV signals being conducted along a primary through line onto one or more tap lines, where the tap lines deliver the CATV signals to one or more subscriber premises. The disclosed cable tap device includes a CATV signal conditioning circuit which conditions the CATV signals being conducted along the tap line.

### BACKGROUND OF THE INVENTION

CATV networks use an infrastructure of interconnected coaxial cables, signal splitters and combiners, repeating amplifiers, filters, trunk lines, cable taps, drop lines and other signal-conducting devices to supply and distribute high frequency “downstream” CATV signals from a main signal distribution facility, known as a “headend,” to the premises (homes and offices) of subscribers to the CATV services. The downstream CATV signals transfer multimedia content to subscriber equipment, such as television sets, telephone sets and computers. In addition, most CATV networks also transmit “upstream” CATV signals from the subscriber equipment back to the headend of the CATV network. For example, the subscriber uses a set top box to select programs for display on the television set. As another example, two-way communication is essential when using a personal computer connected through the CATV infrastructure to the internet. As a further example, Voice over Internet Protocol (VoIP) telephone sets use the CATV infrastructure and the internet as the communication medium for transmitting two-way telephone conversations.

To permit simultaneous communication of upstream and downstream CATV signals and the interoperability of the subscriber equipment and the equipment associated with the CATV network infrastructure outside of subscriber premises, the downstream and upstream CATV signals are confined to two different frequency bands. The downstream CATV signal frequency band is within the frequency range of 54-1002 megahertz (MHz) and the upstream CATV signal frequency band is within the frequency range of 5-42 MHz in most CATV networks. The entire CATV signal frequency band is therefore 5-1002 MHz. The upstream CATV signal frequency band is different than the downstream CATV signal frequency band, where ‘different than’ means the frequency ranges do not overlap.

The downstream CATV signals are delivered from the CATV network infrastructure to the subscriber premises from a main line through a cable tap device, also called a cable tap. A cable tap device taps off a portion of the signals into a secondary line, which then distributes the tapped signals to subscriber premises or to additional cable tap or signal distribution devices. Downstream CATV signals eventually arrive at the subscriber premises at a CATV entry adapter, which is also commonly referred to as an entry device, terminal adapter or a drop amplifier. The CATV entry adapter is usually a multi-port device which provides a multiplicity of ports or connectors for connecting coaxial cables. A separate coaxial cable is connected to each of the ports and extends within the subscriber premises to the location of the subscriber equipment. Some homes have coaxial cables extending to cable outlets in almost every room, because of the many different types of subscriber equipment used in different rooms. For example, television sets are commonplace throughout the home. The multiple ports of the CATV entry adapter deliver downstream CATV at each cable outlet and conduct upstream CATV signals back through the premises coaxial cables to the CATV entry adapter, which delivers the upstream CATV signals to the CATV network.

In addition to television sets, computers and telephones, a relatively large number of other entertainment and multimedia devices are available for use in homes. For example, a digital video recorder (DVR) is used to store broadcast programming, still photography and moving pictures in a memory medium so that the content can be replayed on a display or television set at a later time selected by the user. As another example, computer games are also played at displays or on television sets. Such computer games may be obtained or played over the internet from the CATV network or from media played on play-back devices or game consoles connected to displays or television sets. As a further example, receivers which receive satellite-broadcast signals may be distributed for viewing or listening throughout the home. These types of devices, including the more-conventional television sets, telephone sets and devices connected to the Internet by the CATV network, are generically referred to as multimedia devices.

The desire to use multimedia devices at multiple different locations within the home or subscriber premises has led to the creation of in-home entertainment (IHE) networks, which distribute multiple streams of in-home entertainment signals to the multimedia devices within the subscriber premises. Examples of home networking technologies that can be used to create IHE networks include Ethernet, HomePlug, HPNA, and 802.11n. In another example, the IHE network may employ technology standards developed by the Multimedia over Coax Alliance. The Multimedia over Coax Alliance (MoCA) has developed specifications for products to create an in-home entertainment (IHE) network for interconnecting presently-known and future multimedia devices.

An IHE network uses the subscriber premise or in-home coaxial cable infrastructure originally established for distribution of CATV signals within the subscriber premises, principally because that coaxial cable infrastructure already exists in most homes and is capable of carrying much more information than is carried in the CATV frequency ranges. An IHE network is established by connecting IHE-enabled devices or IHE interface devices at the cable outlets in the rooms of the subscriber premises. The IHE devices and the IHE interface devices implement an IHE communication protocol which encapsulates the signals normally used by the multimedia devices within IHE signal packets and then communicates the IHE signal packets between other IHE interface devices connected at other cable outlets. The receiving IHE interface device removes the encapsulated multimedia signals from the IHE signal packets, and delivers the multimedia signals to the connected display, computer or other multimedia device from which the content is presented to the user.

Each IHE-enabled device is capable of communicating with every other IHE-enabled device in the in-home or subscriber premises network to deliver the multimedia content throughout the home or subscriber premises. The multimedia content that is available from one multimedia device can be displayed, played or otherwise used on a different IHE-enabled device at a different location within the home, thereby avoiding physically relocating the originating multimedia device from one location to another within the subscriber premises. The communication of multimedia content over the IHE network is considered beneficial in more fully utilizing the multimedia devices present in modern homes.

Since the operation of the subscriber premises IHE network must occur simultaneously with the operation of the CATV services, the IHE signals utilize a frequency band different than the frequency band of the CATV upstream and CATV downstream signals, where ‘different than’ means the frequency ranges do not overlap. A typical IHE signal frequency band is a range of frequencies from 1125-1675 megahertz (MHz).

In addition to traditional cable television service, a telephone service, known as “lifeline telephone service,” is also available to many CATV subscribers. Lifeline telephone service remains operative in emergency situations, even during a loss of power to the subscriber premises. An embedded multimedia terminal adapter (eMTA) device which includes a cable modem and a telephone adapter is used to receive the telephone service. The telephone service is typically implemented using a Voice over Internet Protocol (VOIP) communicated by the CATV upstream and downstream signals. Since the telephone service is expected to be available during a loss of power to the subscriber premises, CATV entry adapters adapted for use with an eMTA device have a passive port to which passive CATV upstream and downstream signals are conducted without amplification or other conditioning by an active electronic component. As a consequence, the loss of power at the subscriber premises does not adversely affect the communication of passive CATV signals to and from the passive port

In addition to the passive port, CATV entry adapters typically have an active signal communication path which amplifies the CATV downstream signals and conducts them to a plurality of active ports of the CATV entry adapter. Subscriber equipment connected to the active ports typically benefits from the amplification of the CATV downstream signals. However, the loss of power to the entry adapter adversely influences the active signals conducted to and from the active ports through power-consuming components which become inoperative when power is lost. The communication of active CATV signals under power loss conditions is severely compromised or impossible.

Many eMTA devices used for passive CATV signal communication are not presently IHE-enabled. However, IHE-enabled eMTA devices are recognized as useful for expanding the number of multimedia devices in the IHE network. For example, telephony multimedia devices such as auxiliary telephone sets and answering machines could interact with an IHE-enabled eMTA device and provide telephony services throughout the subscriber premises. In order for multimedia devices to communicate with the IHE-enabled eMTA device, the CATV entry adapter must be capable of communicating IHE signals between the passive and active ports.

A disadvantage of implementing the IHE network with the in-home coaxial cable system is that the IHE frequencies have the capability of passing through the CATV entry device and entering the CATV network, where they may then pass through a cable tap or a cable drop and enter an adjoining subscriber's premises.

The presence of the IHE signals at an adjoining subscriber's premises compromises the privacy and security of the information originally intended to be confined only within the original subscriber premises. The IHE signals from the original subscriber premises, which enter through the CATV network to an adjoining subscriber premises, also have the potential to adversely affect the performance of an IHE network in the adjoining subscriber premises. The conflict of the signals from the original and adjoining subscriber premises may cause the IHE interface devices to malfunction or not operate properly on a consistent basis.

CATV networks are subject to adverse influences from so-called ingress noise which enters the CATV network from external sources, many of which are located at the subscriber premises. The typical range of ingress noise is in the frequency range of 0-15 MHz, but can also exist in other upstream or downstream frequencies. Ingress noise mitigation devices have been developed to suppress or reduce ingress noise from the subscriber premises before it enters the CATV network. The IHE frequency range is considerably outside the range of the normal ingress noise, and ingress noise suppression devices are ineffectual in inhibiting IHE signals. IHE signals, being outside of the CATV signal frequency range, may also constitute another source of noise for the CATV network. Separate IHE frequency rejection filters have been developed for external connection to CATV entry adapters. However, the use of such devices is subject to unauthorized removal, tampering, forgetfulness in original installation, and physical exposure which could lead to premature failure or malfunction.

### SUMMARY OF THE INVENTION

This invention relates to cable television (CATV) networks and to in-home entertainment (IHE) networks which share existing coaxial cables within a subscriber premises for distribution of CATV and in-home entertainment communication signals. More particularly, the present invention relates to a cable tap device which divides a main CATV signal into a primary through line and one or more tap lines, where the tap lines deliver signals to one or more subscriber premises. The disclosed cable tap device includes a CATV signal conditioning circuit which conditions signal being conducted along a tap line.

Disclosed is a cable television (CATV) cable tap device for conducting downstream and upstream CATV signals within a CATV network. The CATV cable tap device includes an entry port; a through port; one or more than one tap port; a signal splitting device having an input terminal and at least two output terminals; a tap signal transmission path; and an in-home entertainment signal frequency rejection filter electrically connected along the tap signal transmission path. The input terminal is electrically connected to the entry port, and a first one of the at least two output terminals is electrically connected to the through port. The tap signal transmission path conducts the downstream and the upstream CATV signals between a second one of the at least two output terminals and a first one of the one or more than one tap port. Both the upstream and the downstream CATV signals pass through the in-home entertainment signal frequency rejection filter. The in-home entertainment signal frequency rejection filter blocks transmission of in-home entertainment signals through the in-home entertainment signal frequency rejection filter.

In some embodiments of the CATV cable tap device according to the invention, the downstream CATV signals are in a downstream CATV signal frequency band and the upstream CATV signals are in an upstream CATV signal frequency band. The upstream CATV signal frequency band is different than the downstream CATV signal frequency band. The in-home entertainment signals are in an in-home entertainment signal frequency band, where the in-home entertainment signal frequency band is different than both the downstream CATV signal frequency band and the upstream CATV signal frequency band. In some embodiments the downstream and the upstream CATV signals pass through the in-home entertainment frequency rejection filter without substantial attenuation. In some embodiments the downstream CATV signal frequency band is a range of frequencies from 54 megahertz to 1002 megahertz, the upstream CATV signal frequency band is a range of frequencies from 5 megahertz to 42 megahertz, and the in-home entertainment signal frequency band is a range of frequencies from 1125 megahertz to 1675 megahertz.

In some embodiments the tap signal transmission path includes a first branch node electrically coupled to the tap signal transmission path; a second branch node electrically coupled to the tap signal transmission path; a downstream CATV signal transmission path, where the downstream CATV signal transmission path conducts downstream CATV signals between the first branch node and the second branch node; and an upstream CATV signal transmission path. The upstream CATV signal transmission path is in parallel electrical connection with the downstream CATV signal transmission path, and the upstream CATV signal transmission path conducts upstream CATV signals between the first branch node and the second branch node.

In some embodiments the upstream CATV signal transmission path includes a CATV upstream frequency bandpass filter electrically coupled to the upstream CATV signal transmission path, where the CATV upstream frequency bandpass filter passes upstream CATV signals in the upstream CATV signal frequency band and rejects downstream CATV signals in the downstream CATV signal frequency band. In some embodiments the upstream CATV signal transmission path includes an ingress noise mitigation circuit electrically coupled to the upstream CATV signal transmission path, where the ingress noise mitigation circuit mitigates ingress noise transmission along the upstream CATV signal transmission path.

In some embodiments the downstream CATV signal transmission path includes a CATV downstream frequency bandpass filter electrically coupled to the downstream CATV signal transmission path, where the CATV downstream frequency bandpass filter rejects upstream CATV signals in the upstream CATV signal frequency band and passes downstream CATV signals in the downstream CATV signal frequency band.

Disclosed is a cable television (CATV) cable tap device according to the invention. The cable tap device is for conducting downstream and upstream CATV signals within a CATV network. The CATV cable tap device according to the invention includes a through signal transmission path, where the through signal transmission path conducts the downstream and the upstream CATV signals through the cable tap device between an entry port and a through port of the cable tap device. The CATV cable tap device according to the invention also includes a signal splitting device coupled to the through signal transmission path between the entry port and the through port, and a tap signal transmission path, where the tap signal transmission path branches from the through signal transmission path at the signal splitting device, and where the tap signal transmission path conducts the downstream and the upstream CATV signals between the signal splitting device and a tap port of the cable tap device. The CATV cable tap device according to the invention also includes a first branch node electrically coupled to the tap signal transmission path; a second branch node electrically coupled to the tap signal transmission path; and a downstream CATV signal transmission path, where the downstream CATV signal transmission path conducts the downstream CATV signals between the first branch node and the second branch node. The CATV cable tap device according to the invention also includes a CATV downstream frequency bandpass filter electrically coupled to the downstream CATV signal transmission path. The CATV cable tap device according to the invention also includes an upstream CATV signal transmission path in parallel electrical connection with the downstream CATV signal transmission path between the first branch node and the second branch node, where the upstream CATV signal transmission path conducts the upstream CATV signals between the first branch node and the second branch node. The upstream CATV signal transmission path includes a CATV upstream frequency bandpass filter electrically coupled to the upstream CATV signal transmission path; and an ingress noise mitigation circuit electrically coupled to the upstream CATV signal transmission path, where the ingress noise mitigation circuit mitigates ingress noise transmission along the upstream CATV signal transmission path.

In some embodiments the tap signal transmission path further includes an in-home entertainment signal frequency rejection filter electrically connected to the tap signal transmission path, where both the upstream and the downstream CATV signals pass through the in-home entertainment signal frequency rejection filter, and where the in-home entertainment signal frequency rejection filter blocks transmission of in-home entertainment signals through the in-home entertainment signal frequency rejection filter. In some embodiments the downstream CATV signal frequency band is a range of frequencies from 54 megahertz to 1002 megahertz, the upstream CATV signal frequency band is a range of frequencies from 5 megahertz to 42 megahertz, and the in-home entertainment signal frequency band is a range of frequencies from 1125 megahertz to 1675 megahertz. In some embodiments the CATV downstream frequency bandpass filter is a first CATV downstream frequency bandpass filter, and the downstream CATV signal transmission path further includes a second CATV downstream frequency bandpass filter. In some embodiments the downstream CATV signal transmission path further comprises an amplifier, where the amplifier amplifies the downstream CATV signals. In some embodiments the CATV upstream frequency bandpass filter is a first CATV upstream frequency bandpass filter, and the upstream CATV signal transmission path further includes a second CATV upstream frequency bandpass filter.

Disclosed is a method according to the invention of distributing downstream cable television (CATV) signals in a CATV downstream signal frequency band and upstream CATV signals in a CATV upstream signal frequency band. The method according to the invention includes the steps of conducting a first portion of the downstream and the upstream CATV signals through a cable tap device between an entry port and a through port; conducting a second portion of the downstream and the upstream CATV signals through the cable tap device between the entry port and a tap port; and filtering the second portion of the downstream and the upstream CATV signals through an in-home entertainment signal frequency rejection filter, where the in-home entertainment signal frequency rejection filter passes the downstream CATV signals, and where the in-home entertainment signal frequency rejection filter passes the upstream CATV signals, and where the in-home entertainment signal frequency rejection filter blocks in-home entertainment signals in an in-home entertainment signal frequency band from passing through the in-home entertainment signal frequency rejection filter.

In some embodiments the method includes the step of splitting the downstream CATV signals in the second portion of the downstream and the upstream CATV signals from the upstream CATV signals in the second portion of the downstream and the upstream CATV signals. In some embodiments the method includes the step of preventing the upstream CATV signals in the second portion of the downstream and the upstream CATV signals from reaching the entry port when it is detected that the upstream CATV signals in the second portion of the downstream and the upstream CATV signals comprise noise instead of a valid upstream CATV signal. In some embodiments the step of preventing the upstream CATV signals in the second portion of the downstream and the upstream CATV signals from reaching the entry port when it is detected that the upstream CATV signals in the second portion of the downstream and the upstream CATV signals comprise noise instead of a valid upstream CATV signal comprises the step of preventing the upstream CATV signals in the second portion of the downstream and the upstream CATV signals from reaching the entry port when it is detected that an instantaneous level of power of the upstream CATV signals does not exceed a predetermined threshold level of power.

### BRIEF DESCRIPTION OF THE DRAWINGS

FIG. 1 is a block diagram illustrating a typical CATV network infrastructure, including cable tap device 36 according to the invention, headend 24, entry adapters 10, and subscriber equipment 16 and 21.

FIG. 2 is a simplified schematic diagram of an embodiment of cable tap device 36 according to the invention, where cable tap device 36 includes through signal transmission path 236, signal splitting device 228, CATV signal conditioning circuit 212, and tap signal transmission path 240.

FIG. 3 is a simplified schematic of a further embodiment of cable tap device 36 according to the invention, where cable tap device 36 includes through signal transmission path 236, a plurality of signal splitting devices 228a through 228n and a plurality of tap signal transmission paths 240a through 240n, where each tap signal transmission path 240 includes a CATV signal conditioning circuit 212a through 212n.

FIG. 4 is a block diagram of an embodiment of CATV signal conditioning circuit 212, where CATV signal conditioning circuit 212 includes in-home entertainment signal frequency rejection filter 70 electrically connected to tap signal transmission path 240.

FIG. 5 is a block diagram of a further embodiment of CATV signal conditioning circuit 212, where CATV signal conditioning circuit 212 includes downstream CATV signal transmission path 254 and upstream CATV signal transmission path 256.

FIG. 6 is a block diagram of another embodiment of CATV signal conditioning circuit 212, where CATV signal conditioning circuit 212 includes downstream CATV signal transmission path 254 and upstream CATV signal transmission path 256 and in-home entertainment signal frequency rejection filter 70.

FIG. 7 is a block diagram of an embodiment of ingress noise mitigation circuit 100 according to the invention.

FIGS. 8, 9 and 10 contain multiple waveform diagrams on a common time axis, illustrating the functional features of ingress noise mitigation circuit 100 of cable tap device 36 as shown in FIG. 7.

FIG. 11 is a block diagram of an embodiment of ingress noise mitigation circuit 160 according to the invention.

FIGS. 12, 13 and 14 contain multiple waveform diagrams on a common time axis, illustrating the functional features of ingress noise mitigation circuit 160 of cable tap device 36 as shown in FIG. 11.

### DETAILED DESCRIPTION

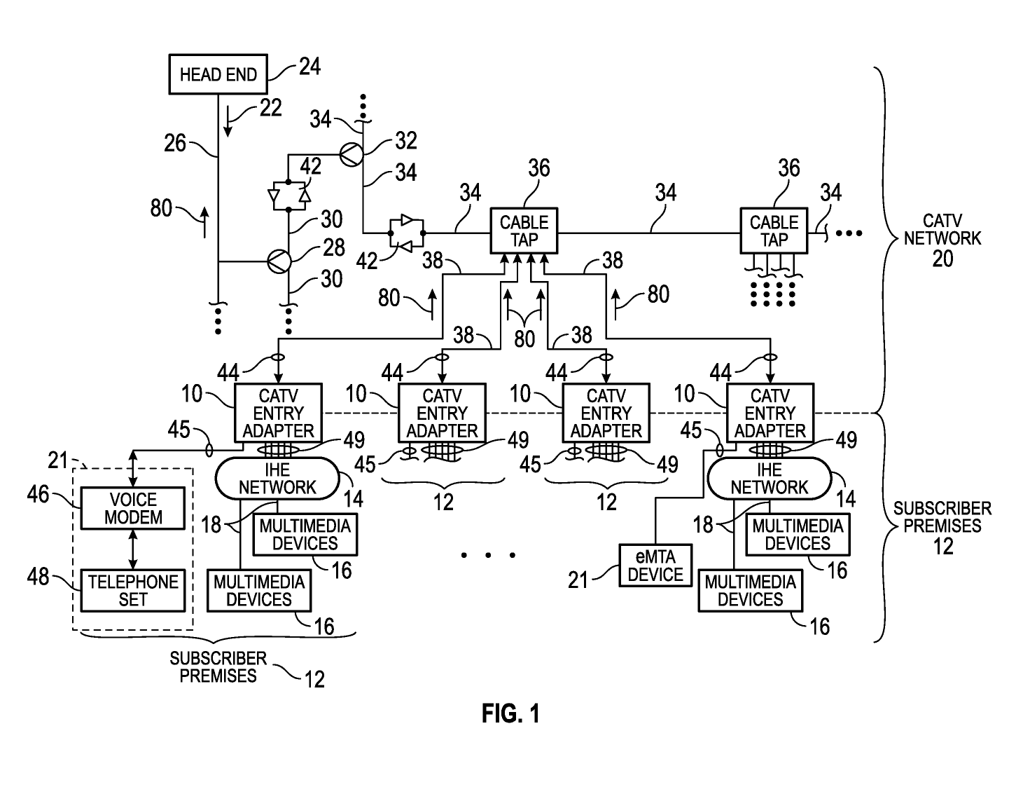

A cable television (CATV) cable tap device 36 which incorporates the disclosed invention is shown generally in FIG. 1. Cable tap device 36 according to the invention conducts downstream CATV signals 22 and upstream CATV signals 80 within CATV network 20. Downstream CATV signals 22 are delivered from CATV network headend 24 to subscriber premises 12 from main line 26 through CATV network 20. CATV network 20 has a typical topology. Downstream signals 22 originate from programming sources at headend 24 of CATV network 20, and are conducted to CATV entry adapter 10 in a sequential path through main trunk cable 26, signal splitter/combiner 28, secondary trunk cables 30, another signal splitter/combiner 32, distribution cable branches 34, cable taps 36, and drop cables 38. Upstream signals 80 originating from subscriber equipment 16 and 21 are delivered from subscriber premises 12 through CATV entry adapter 10 to CATV network 20, and are conducted to headend 24 in the same path but in reverse sequence. Interspersed at appropriate locations within the topology of CATV network 20 are conventional repeater amplifiers 42, which amplify both downstream CATV signals 22 and upstream CATV signals 80. Conventional repeater amplifiers may also be included in cable taps 36. Cable taps 36 and signal splitter/combiners 28 and 32 divide a single downstream CATV signal 22 into multiple separate downstream CATV signals, and combine multiple upstream CATV signals 80 into a single upstream CATV signal.

CATV cable tap devices 36 are positioned wherever it is desirable to divide or tap off one or more CATV signal paths and direct them to subscriber premises 12 such as homes, offices, or Multiple Dwelling Units (MDUs). MDUs include apartments, condos, or other structures which house multiple individual units.

Cable tap device 36 splits or taps off a portion of the CATV signals into a secondary line, which then distributes the tapped signals to subscriber premises 12 or to additional cable taps 36 or other signal distribution devices. Downstream CATV signals 22 eventually arrive at subscriber premises 12 at CATV entry adapter 10. CATV entry adapter 10 is located at subscriber premises 12 and forms a part of a conventional in-home entertainment (IHE) network 14, such as a conventional Multimedia over Coax Alliance (MoCA) in-home entertainment network. The IHE network 14 interconnects subscriber equipment or multimedia devices 16 within the subscriber premises 12, and allows the multimedia devices 16 to communicate multimedia content or in-home entertainment signals between other multimedia devices 16. The connection medium of the IHE network 14 is formed in significant part by a preexisting CATV coaxial cable infrastructure (represented generally by coaxial cables 18) present in the subscriber premises 12 and originally intended to communicate CATV signals between the multimedia or subscriber devices 16 and/or 21 However the connection medium of the IHE network 14 may be intentionally created using newly-installed coaxial cables 18. Examples of multimedia devices 16 are digital video recorders, computers, data modems, computer game playing devices, television sets, television set-top boxes, and other audio and visual entertainment devices.

CATV entry adapter 10 is also a part of conventional CATV network 20. CATV entry adapter 10 delivers downstream CATV signals 22 from CATV network 20 to subscriber equipment 16 and 21 at subscriber premises 12. The subscriber equipment includes the multimedia devices 16, but may also include other devices which may or may not operate as a part of the IHE network 14 but which are intended to function as a result of connection to CATV network 20.

CATV entry adapter 10 receives CATV downstream signals 22 from CATV headend 24 through CATV cable tap device 36 at a CATV network connection or entry port 44. Passive downstream signals are conducted through CATV entry adapter 10 to eMTA device 21 without amplification, enhancement, modification, or other substantial conditioning. EMTA device 21 is represented by voice modem 46 connected to telephone set 48. Active downstream CATV signals 22 are amplified, filtered, modified, enhanced or otherwise conditioned by power-consuming active electronic circuit components within CATV entry adapter 10, such as an amplifier, for example. Active downstream CATV signals 22 are divided into multiple copies, and a copy is delivered from each of a plurality of active ports 49. The active downstream CATV signals 22 are delivered to active subscriber equipment located at subscriber premises 12.

The CATV subscriber equipment 16 and 21 typically generates upstream CATV signals 80 and delivers them to CATV entry adapter 10 for delivery to CATV network 20, specifically to CATV headend 24 through one or more cable taps 36. Upstream CATV signals 80 may be passive upstream CATV signals 80 generated by eMTA device 21, or upstream CATV signals 80 may be active upstream CATV signals 80 generated by active subscriber equipment or multimedia devices 16, as exemplified by set top boxes connected to television sets (neither shown). Set top boxes allow the subscriber/viewer to make programming and viewing selections.

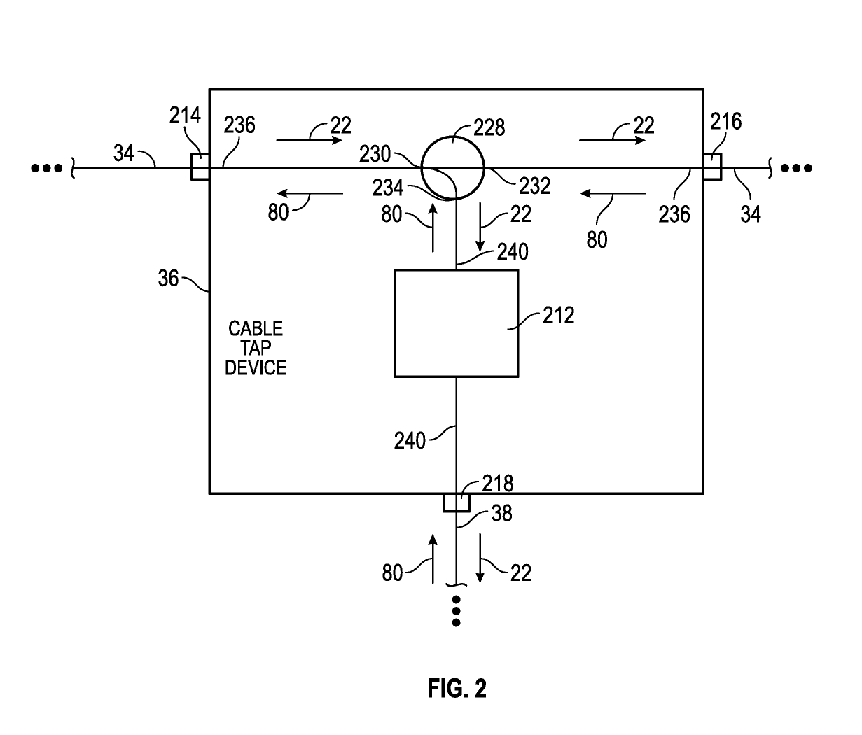

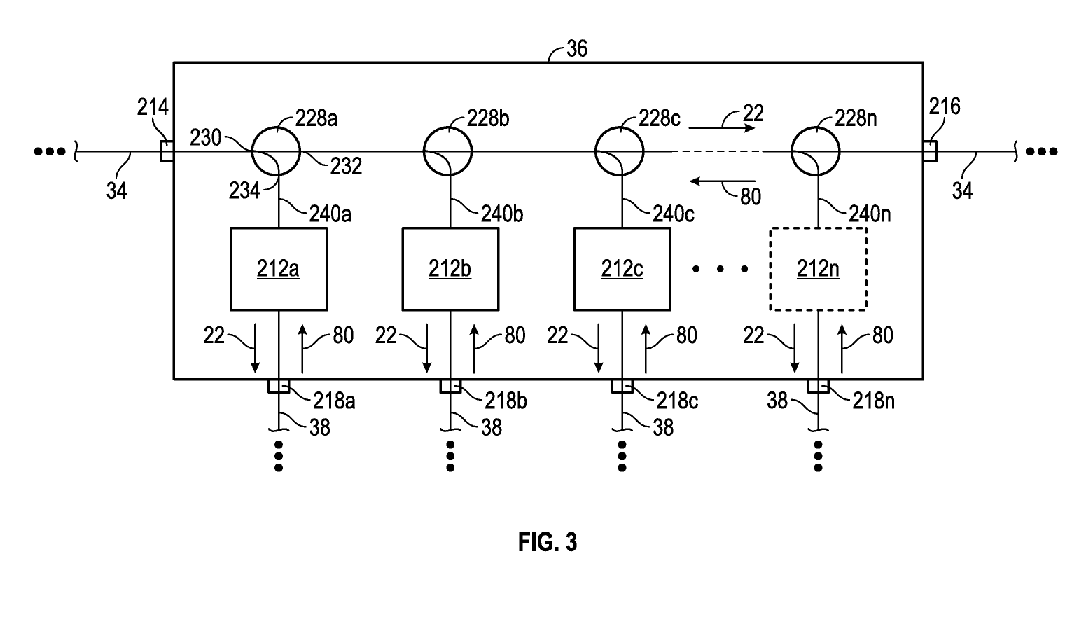

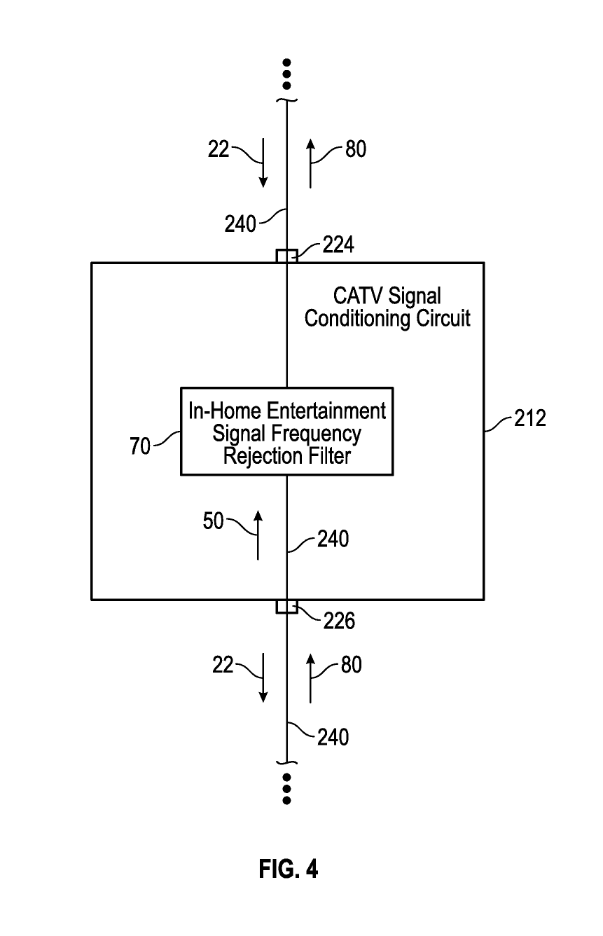

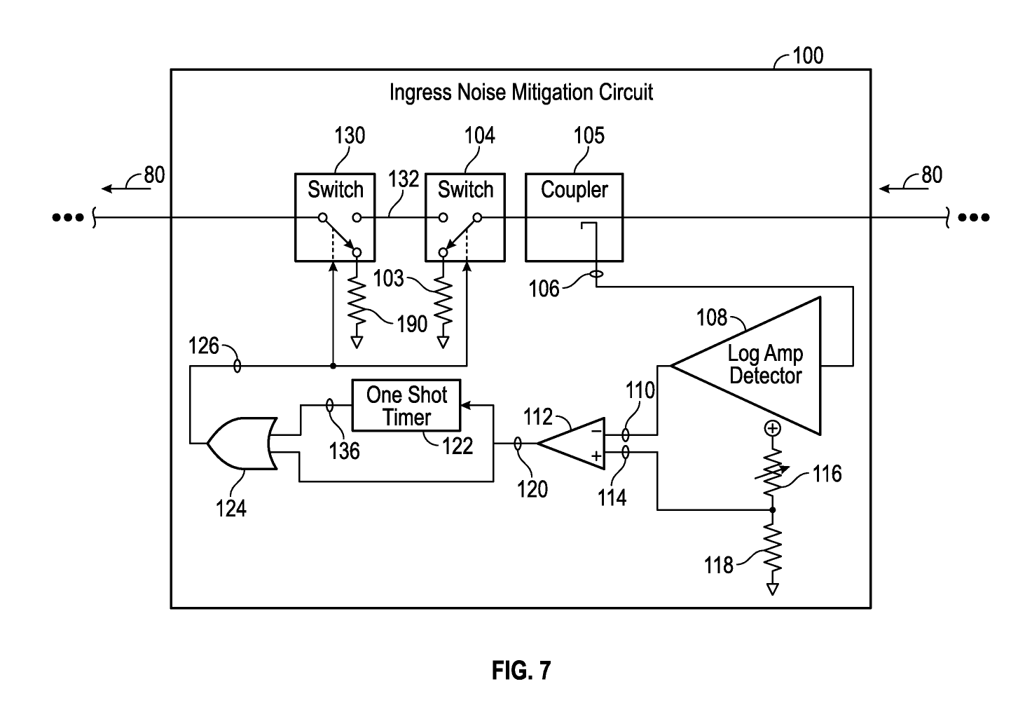

As discussed earlier, cable tap devices 36 are part of CATV network 20 and provide signal distribution of downstream CATV signals 22 and upstream CATV signal 80 between main CATV signal distribution lines to subscriber premises 12. Further details regarding embodiments of cable taps 36 are shown in FIG. 2 through FIG. 14. FIG. 2 and FIG. 3 each show block diagrams of embodiments of cable taps 36 according to the invention. FIG. 4 through FIG. 6 show embodiments of CATV signal conditioning circuit 212 of cable tap 36. FIG. 7 through FIG. 14 show details of ingress noise mitigation circuits 100 and 160 of CATV signal conditioning circuit 212.

FIG. 2 shows a block diagram of an embodiment of cable tap device 36 according to the invention. In this embodiment, cable tap 36 includes entry port 214, through port 216, and through signal transmission path 236 which conducts downstream and upstream CATV signals 22 and 80 through cable tap device 36. Through signal transmission path 236 conducts a first portion of downstream and upstream CATV signals 22 and 80 through cable tap device 36. Cable branch 34 delivers downstream CATV signals 22 to entry port 214 and receives CATV upstream CATV signals 80 from CATV network 20 at through port 216. Tap signal transmission path 240 conducts a second portion of downstream and upstream CATV signals 22 and 80 from signal splitting device 228 to tap port 218. Drop cable 38 connects to tap port 218 and receives downstream CATV signal 22 from cable tap 36, and delivers upstream CATV signal 80 to cable tap 36.

Cable tap device 36 includes one or more than one signal splitting device 228, where each of the one or more than one signal splitting devices 228 splits off a portion of the signals being conducted along through transmission path 236 to be delivered to tap port 218. In the embodiment shown in FIG. 2, cable tap device 36 includes one signal splitting device 228 and one tap port 218. Cable tap 36 according to the invention can include any number of signal splitting devices 228 (see FIG. 3), which each split or tap off a portion of downstream CATV signals 22 from through signal transmission path 236 and deliver the portion of the downstream CATV signals 22 to a tap port 218.

Signal splitting device 228 is shown in the figures as directional coupler 228, but it is to be understood that signal splitting device 228 can be any type of device which splits a single signal into more than one signal. In this case signal splitting device 228 splits downstream CATV signals 22 received from entry port 214 into a first portion of downstream CATV signals 22, which is conducted to through port 216, and a second portion of downstream CATV signals 22, which is conducted to tap port 218. Signal splitting device 228 includes input terminal 230, first output terminal 232, and second output terminal 234. Signal splitting device 228 includes at least two output terminals, but can include more than two output terminals. Input terminal 230 is electrically connected to entry port 214. First output terminal 232 is electrically connected to through port 216. Second output terminal 234 is electrically connected to tap port 218 through CATV signal conditioning circuit 212. Signal splitting device 228 also combines upstream CATV signals 80 received at first output terminal 232 and second output terminal 234, combines them into a single upstream CATV signal 80, and delivers the single upstream CATV signal 80 to input terminal 230.

Tap signal transmission path 240 according to the invention includes CATV signal conditioning circuit 212 in this embodiment. CATV signal conditioning circuit 212 conditions downstream and upstream CATV signals 22 and 80 as described below. CATV signal conditioning circuit 212 can include many different types of components, several of which are described herein.

FIG. 3 shows a further embodiment of cable tap device 36, where cable tap device 36 includes a plurality of signal splitting devices 228a through 228n, a plurality of signal conditioning circuits 212a through 212n, and a plurality of tap ports 218a through 218n. Each signal splitting device 228 taps off a portion of the signals from through signal transmission path 236 and send the signals to a tap port 218 through a signal conditioning circuit 212. Cable tap device 36 according to the invention can include any number of signal splitting devices 228, tap ports 218, and signal conditioning circuits 212. Each tap signal transmission path does not have to include a signal conditioning circuit 212, as exemplified by the optional (dotted line) signal conditioning circuit 212n of tap signal transmission path 240n shown in FIG. 3. In some embodiments of cable tap 36, only one tap signal transmission path 240 includes a signal conditioning circuit 212. In some embodiments of cable tap 36, each tap signal transmission path 240 includes a signal conditioning circuit 212. In some embodiments of cable tap 36, some of the plurality of tap signal transmission paths 240 includes a signal conditioning circuit 212.

FIG. 4 through FIG. 6 show various embodiments of signal conditioning circuit 212 according to the invention of cable tap 36 according to the invention. Tap signal transmission path 240 conducts downstream and upstream CATV signals 22 and 80 through signal conditioning circuit 212 between signal conditioning circuit input port 224 and signal conditioning circuit output port 226.

In the embodiment of cable tap device 36 shown in FIG. 4, signal conditioning circuit 212 includes in-home entertainment (IHE) signal frequency rejection filter 70. IHE signal frequency rejection filter 70 blocks transmission of IHE signals 50, but allows transmission of downstream and upstream CATV signals 22 and 80. IHE signal frequency rejection filter blocks transmission of IHE signals 50 so that IHE signals 50 that happen to enter CATV network 20 from subscriber premises 12 do not get conducted to headend 24 or to another subscriber premises. Both upstream CATV upstream signals 80 and downstream CATV signals 22 pass through in-home entertainment signal frequency rejection filter 70, but in-home entertainment signal frequency rejection filter 70 blocks transmission of in-home entertainment signals 50 through in-home entertainment signal frequency rejection filter 70. Both upstream CATV upstream signals 80 and downstream CATV signals 22 pass through in-home entertainment signal frequency rejection filter 70 without substantial attenuation, where substantial attenuation is an attenuation of about 3 decibels (dB).

In the embodiment of signal conditioning circuit 212 of FIG. 4, IHE signal frequency rejection filter 70 causes CATV signal conditioning circuit 212 to allow downstream CATV signals 22 to pass through signal conditioning circuit 212 along tap signal transmission path 240 between signal conditioning circuit input port 224 and signal conditioning circuit output port 226. And IHE signal frequency rejection filter 70 causes CATV signal conditioning circuit 212 to block transmission of in-home entertainment signals 50 through signal conditioning circuit 212. In this way signal conditioning circuit 212 as shown in FIG. 4 conditions signals passing upstream by removing the IHE signal frequency band from the upstream signals. IHE signal frequency rejection filter 70 filters the second portion of downstream CATV signals 22 and upstream CATV signals 80 being conducted along tap signal transmission path 240.

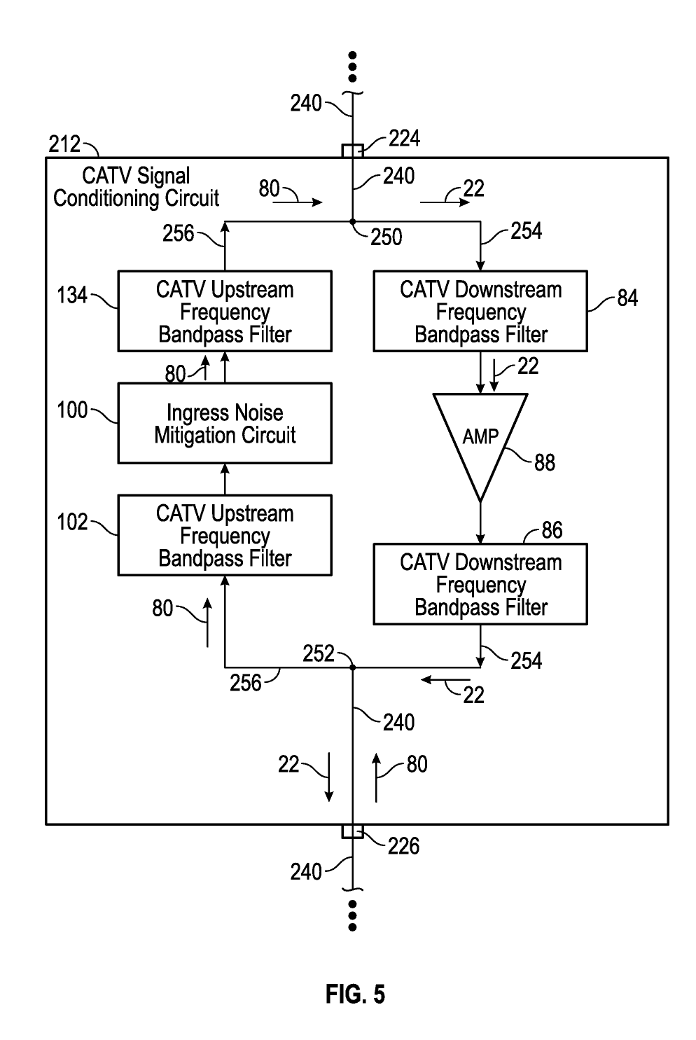

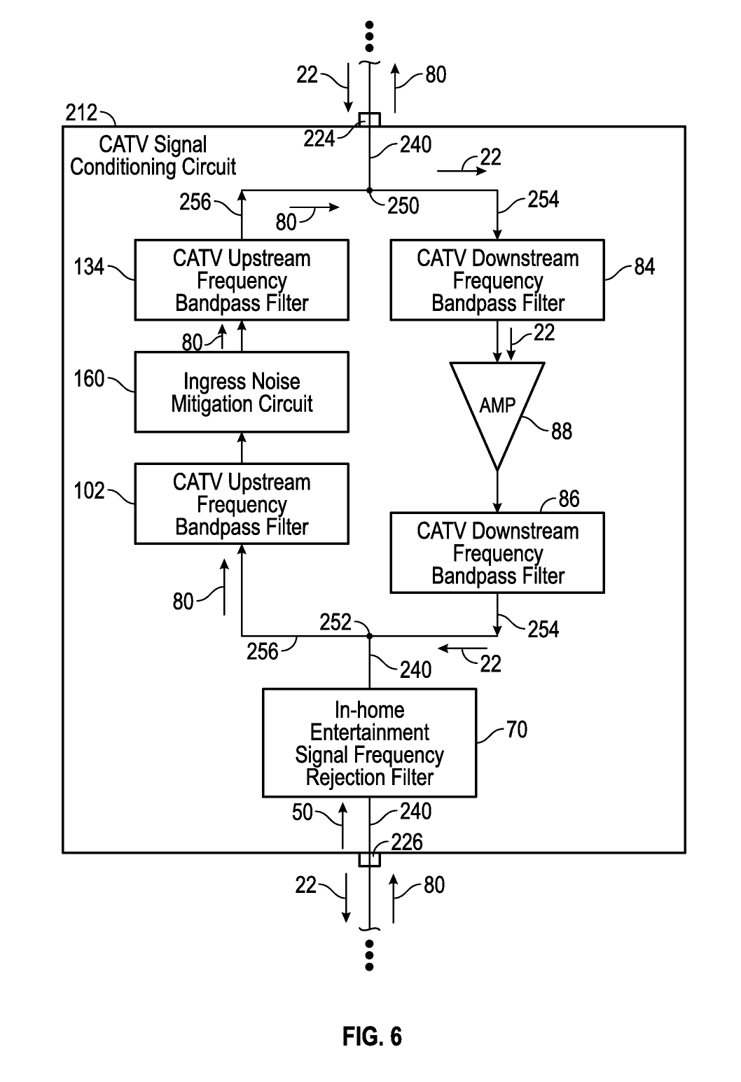

FIG. 5 and FIG. 6 show further embodiments of CATV signal conditioning circuit 212. In these embodiments, CATV signal conditioning circuit 212 includes ingress noise mitigation circuit 100 or 160, which mitigates ingress noise that is in upstream CATV signals 80, as explained further below. In order to remove ingress noise from upstream CATV signals 80, upstream CATV signals 80 and downstream CATV signal 22 must be separated, as shown in FIG. 5 and FIG. 6. In the embodiments of signal conditioning circuit 212 of FIG. 4 and FIG. 5, CATV signal conditioning circuit 212 includes first branch node 250 and second branch node 252. In between first branch node 250 and second branch node 252, tap signal transmission path 240 is separated into downstream CATV signal transmission path 254 and upstream CATV signal transmission path 256. Downstream CATV signal transmission path 254 conducts downstream CATV signals 22 between first branch node 250 and second branch node 252. Upstream CATV signal transmission path 256 conducts upstream CATV signals 80 between second branch node 252 and first branch node 250. Upstream CATV signal transmission path 256 and downstream CATV signal transmission path 254 are in parallel electrical connection with each other between first branch node 250 and second branch node 252. In this way downstream CATV signals 22 in the second portion of downstream CATV signals 22 and upstream CATV signals 80 are split from the upstream CATV signals 80 in the second portion of downstream CATV signals 22 and upstream CATV signals 80.

Downstream CATV signal transmission path 254 includes CATV downstream frequency bandpass filter 84, which passes downstream CATV signals 22 in the downstream CATV signal frequency band, and rejects upstream CATV signals 80 in the upstream CATV signal frequency band. CATV downstream frequency bandpass filter 84 allows only downstream CATV signals 22 to be conducted between first branch node 250 and second branch node 252 on downstream CATV signal transmission path 254. In the embodiment shown in FIG. 5 and FIG. 6, downstream CATV signal transmission path 254 also includes amp 88 and CATV downstream frequency bandpass filter 86, although these are optional elements. Amp 88 amplifies downstream CATV signals 22 to ensure downstream CATV signals 22 have enough power to make it to subscriber premises 12. CATV downstream frequency bandpass filter 86 further ensures that signals outside of the downstream CATV signal frequency band do not get conducted along downstream CATV signal transmission path 254. CATV downstream signal transmission path 254 can include many other signal conditioning, amplifying, or filtering elements.

Upstream CATV signal transmission path 256 of FIG. 5 and FIG. 6 includes CATV upstream frequency bandpass filter 102 and ingress noise mitigation circuit 100 (FIG. 5) or 160 (FIG. 6). In some embodiments upstream CATV signal transmission path 256 also includes CATV upstream frequency bandpass filter 134, as shown in the figures. CATV upstream frequency bandpass filters 102 and 134 pass upstream CATV signals 80 in the upstream CATV signal frequency band, and rejects downstream CATV signals 22 in the downstream CATV signal frequency band. CATV upstream frequency bandpass filters 102 and 134 allow only upstream CATV signals 80 to be conducted between first branch node 250 and second branch node 252 on upstream CATV signal transmission path 256.

Upstream CATV signal transmission path 256 also includes ingress noise mitigation circuit 100 or 160. Ingress noise mitigation circuit 100 and 160 mitigate ingress noise in the upstream signal path and prevent ingress noise from exiting CATV signal conditioning circuit 212 and cable tap 36 onto CATV network 20 and making it to headend 24. Ingress noise mitigation circuit 100 and 160 prevent upstream CATV signals 80 in the second portion of downstream and upstream CATV signals 22 and 80 from reaching entry port 214 when it is detected that upstream CATV signals 80 in the second portion of downstream and upstream CATV signals 22 and 80 comprise noise instead of a valid upstream CATV signal, as explained in more detail below. Ingress noise mitigation circuit 100 and 160 prevent upstream CATV signals 80 in the second portion of downstream and upstream CATV signals 22 and 80 from reaching entry port 214 when it is detected that an instantaneous level of power of upstream CATV signal 80 does not exceed a predetermined threshold level of power.

FIG. 5 shows an embodiment of CATV signal conditioning circuit 212 where upstream CATV signal transmission path 256 includes ingress noise mitigation circuit 100, and FIG. 6 shows an embodiment of CATV signal conditioning circuit 212 where upstream CATV signal transmission path 256 includes ingress noise mitigation circuit 160.

CATV signal conditioning circuit 212 can include CATV upstream and downstream signal transmission paths 256 and 256 and also IHE signal frequency rejection filter 70, as shown in FIG. 6. In the embodiment shown in FIG. 6, CATV signal conditioning circuit filters IHE signals 50 from tap signal transmission path 240, and mitigates ingress noise in upstream CATV signal transmission path 256.

To be effective, a CATV network must use filters and other components which reduce or eliminate unwanted signals that enter the CATV network from external sources. These undesirable external signals, known as “ingress noise,” have the effect of degrading valid signals, if measures are not taken to suppress or otherwise limit the amount of ingress noise in a CATV network.

The most intense frequency of undesirable ingress noise signals is in the frequency band of 0-15 megahertz (MHz). Valid upstream CATV signals 80 are within the frequency band of 5-42 MHz, which overlaps with the frequency band of the most intense ingress noise. It is therefore impossible or extremely difficult to filter undesirable ingress noise from valid upstream CATV signals when the two electrical signals occupy the same frequency band and both signals may originate at approximately the same location at the subscriber premises. Valid downstream CATV signals 22 are within the frequency band of 54-1000 MHz, so the ingress noise, typically in the 0-15 MHz frequency band, is usually suppressed by filters in the downstream CATV signal frequency band.

Even though the ingress noise is typically in a frequency band different from the downstream CATV signal frequency band, ingress noise can still have adverse influence on both valid downstream and upstream CATV signals. Ingress noise from individual subscribers tends to funnel together and accumulate as a substantial underlying level of base noise on CATV network 20. Valid signals must be distinguished from this base level noise, usually by amplifying the valid CATV signals above the base noise level. A high level of base noise may cause signal amplifiers to clip or distort both the valid downstream and upstream CATV signals during amplification and retransmission of those signals, thereby reducing the information contained in those valid signals. A reduction in the information contained in the signals diminishes the quality of service experienced by the subscriber and may even inhibit the delivery of services to subscribers.

There are many potential sources of ingress noise in the environment of a typical CATV network 20. However, the typical CATV network 20 has a relatively high immunity to ingress noise because the CATV network infrastructure is essentially constructed by professionals using high quality equipment and techniques. However, the situation is usually considerably different at the subscriber premises. The quality of the subscriber equipment, the type and integrity of the signal conductors within the consumer premises, the effectiveness and quality of the connections between the subscriber equipment and the signal conductors, and the presence of many other types of electrical devices which emit noise, such as electric motors, radios and consumer appliances, become sources of ingress noise at the subscriber premises over which the CATV service provider has no control.

Even though the CATV service provider may have little control over the sources of ingress noise at subscriber premises 12, the CATV service provider is nevertheless responsible for the quality of service, at least from the perspective of subscribers. Therefore, different types of ingress noise inhibiting devices have been devised for use with CATV networks to attempt to suppress ingress noise entering the CATV network from the subscriber premises. Described below are ingress noise mitigation circuits 100 and 160 according to the invention, which can be included in CATV signal conditioning circuit 212 of cable tap 36.

In the embodiments of CATV signal conditioning circuit 212 as shown in FIG. 5 and FIG. 6, valid upstream CATV signals 80 from subscriber equipment 16 or 21 are conducted through entry adapter 10, to cable tap 36. Upstream CATV signals 80 enter cable tap 36 at a tap port 218, and then enter CATV signal conditioning circuit 212 at signal conditioning circuit output port 226. Upstream CATV signals 80 are applied to first CATV upstream frequency bandpass filter 102. Because CATV downstream frequency bandpass filter 86 passes signals only in the 54-1000 MHz band, valid upstream CATV signals 80 in the frequency band of 5-42 MHz are blocked by the CATV downstream frequency bandpass filter 86 and diverted through CATV upstream frequency bandpass filter 102. First CATV upstream frequency bandpass filter 102 preferably passes signals in the valid upstream CATV signal frequency range of 5-42 MHz. Typical ingress noise falls most intensely within the frequency range of 0-15 MHz, so first CATV upstream frequency bandpass filter 102 has the capability of removing ingress noise at the low frequencies in the range of 0-5 MHz. However, ingress noise in the range of 5-15 MHz will be conducted by CATV upstream frequency bandpass filter 102.

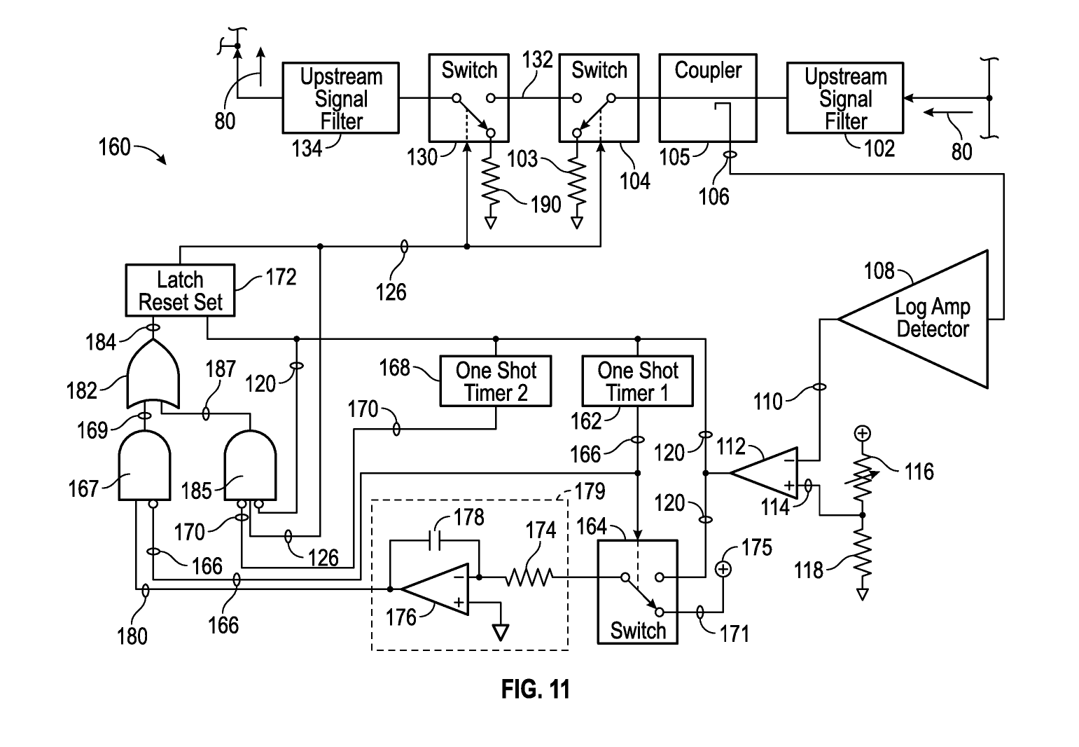

To mitigate or prevent ingress noise in the upstream CATV signals from transmitting through cable tap 36, ingress noise mitigation circuit 100 and 160 are used in upstream CATV signal transmission path 256. FIG. 7 through FIG. 10 show the operation of ingress noise mitigation circuit 100, and FIG. 11 through FIG. 14 show the operation of ingress noise mitigation circuit 160.

Ingress noise mitigation circuit 100 is shown in block diagram in FIG. 7. Ingress noise signals conducted through CATV upstream frequency bandpass filter 102 are isolated by a first radio frequency (RF) single pole double throw (SPDT) electronic switch 104 and terminated to ground through a termination resistor 103. Termination resistor 103 is connected to one terminal of first electronic switch 104. Signals from first CATV upstream frequency bandpass filter 102 are conducted through a conventional directional coupler 105 to and through switch 104 to termination resistor 103 while first electronic switch 104 is in a normal position, shown in FIG. 7. All signals conducted through first CATV upstream frequency bandpass filter 102 are terminated through termination resistor 103, and are thereby prevented from passing through ingress noise mitigation circuit 100 and entering CATV network 20, while the first switch 104 is in its normal position.

First electronic switch 104 changes to an alternate activated position (not shown in FIG. 7) upon the instantaneous power of the signals conducted through CATV upstream frequency bandpass filter 102 reaching a magnitude indicative of a valid upstream CATV signal 80 from subscriber equipment 16 or 21. To distinguish relatively low power ingress noise from the relatively higher power of a valid upstream CATV signal 80, the instantaneous magnitude of the power of the signals passing through CATV upstream frequency bandpass filter 102 is detected and evaluated. Coupler 105 delivers a detection signal 106 which is typically 10 dB lower in power than the main upstream CATV signal 80 passing through coupler 105 to switch 104.

Detection signal 106 from coupler 105 is conducted to an input terminal of a conventional log amplifier detector 108. Log amplifier detector 108 operates on an inverse logarithmic basis to convert the instantaneous magnitude of power of detection signal 106 to a DC voltage output signal 110. By operating on an inverse logarithmic basis, the typical decibel power of detection signal 106 is converted into a linear DC voltage output signal 110 whose magnitude is inversely related to the instantaneous input power. This logarithmic conversion allows log amplifier detector 108 to function as an instantaneous demodulating power detector whose output DC voltage signal is inversely proportional to the logarithm of the input power. A log amp detector 108 which is satisfactory for use in the present invention is part number AD 8319 available from Analog Devices of Norwood Mass., USA. The DC voltage output signal 110 therefore represents the inverse of the instantaneous power of upstream CATV signal 80 conducted through directional coupler 105.

DC voltage output signal 110 from log amp detector 108 is applied to a negative input terminal of a comparator 112. A threshold signal 114 is applied to the positive input terminal of comparator 112. Threshold signal 114 is derived from a resistor divider network such as a potentiometer 116 and a resistor 118 connected in series, or from another voltage source. Adjustment of the value of the potentiometer 116 adjusts the magnitude of the threshold signal 114. The adjustment of the threshold signal 114 establishes the level where a trigger signal 120 from comparator 112 switches from a logic low level to a logic high level.

The magnitude of DC voltage output signal 110 from log amp detector 108 is inversely related to the magnitude of the instantaneous power of the upstream CATV signal 80 represented by detection signal 106. That is, when the magnitude of the detection signal 106 is relatively large, DC voltage output signal 110 from log amp detector 108 is relatively small, and vice versa. Because of this inverse relationship, DC voltage output signal 110 is applied to the negative input terminal of comparator 112, and threshold signal 114 is applied to the positive input terminal of comparator 112. Applying the two input signals in this manner causes comparator 112 to supply a logic high trigger signal 120 whenever the magnitude of the instantaneous power of upstream CATV signal 80, represented by detection signal 106, exceeds a predetermined threshold power level representative of a valid upstream CATV signal. Conversely, when DC voltage output signal 110 is greater than signal 114, trigger signal 120 from comparator 112 is at a logic low level. When DC voltage output signal 110 is less than signal 114, trigger signal 120 from comparator 112 is at a logic high level. The logic high level of signal 120 therefore represents the condition where the instantaneous power of detection signal 106, representing upstream CATV signal 80, exceeds the predetermined threshold power level established by signal 114.

Upon sensing that the instantaneous power content of upstream CATV signal 80 exceeds the level represented by the predetermined threshold power level, upstream CATV signal 80 is immediately transmitted or passed through cable tap 36 to cable network 20, to eventually be received by headend 24. Upstream CATV signals which do not meet the threshold power level are considered ingress noise. Ingress noise signals are isolated from CATV network 20 and headend 24 by switches 104 and 130, while incident upstream CATV signals 80 are simultaneously terminated to ground through termination resistor 103. The functions of passing upstream CATV signals 80 through cable tap 36 and terminating upstream CATV signals 80 to ground are accomplished in response to the logic level of trigger signal 120 from comparator 112.

When the instantaneous power content of upstream CATV signal 80 exceeds the threshold power level, the resulting logic high signal 120 from comparator 112 triggers one-shot timer 122. Simultaneously, the logic high signal 120 is applied to input terminal of OR gate 124. OR gate 124 responds by applying a logic high control signal 126 to the control terminals of the first SPDT RF electronic switch 104 and a second SPDT RF electronic switch 130. The electronic switches 104 and 130 normally occupy the positions shown in FIG. 7. Upon the assertion of logic high control signal 126, switches 104 and 130 immediately change from their normal positions (shown in FIG. 7) to their opposite activated positions (not shown). The activated positions of switches 104 and 130 establish a direct connection over conductor 132 between the switches 104 and 130. Since electronic switches 104 and 130 switch with radio frequency speed, switches 104 and 130 assume the activated position almost instantaneously in response to the assertion of control signal 126.

The activated positions of switches 104 and 130 conduct upstream CATV signal 80 from the first CATV upstream frequency bandpass filter 102 through conductor 132 to a second CATV upstream frequency bandpass filter 134. Both filters 102 and 134 suppress frequencies other than those in the frequency band of 5-42 MHz. The valid upstream CATV signal 80 flows from second CATV upstream frequency bandpass filter 134 through entry port 224 onto cable network 20 as upstream CATV signal 80. Termination resistors 103 and 190 are connected to filters 102 and 134 when switches 104 and 130 are in their normal positions, and filters 102 and 134 are connected together over conductor 132 when switches 104 and 130 are in their activated positions.

Valid upstream CATV signals 80 are conducted through signal conditioning circuit 212 and exit cable tap 36 almost instantaneously when the instantaneous power level of the upstream CATV signal 80 exceeds the threshold power level. By responding almost instantaneously when the threshold power level is exceeded, the chances are minimized that the information contained in the valid upstream CATV signal 80 will be lost, as might be the case if the power of upstream CTV signal 80 had to be integrated over a time period before a determination of a valid upstream CATV signal could be made on the basis of energy content. Such integration raises the possibility that some of the information of upstream CATV signal 80 will be lost and not transferred upstream. In contrast, no integration of the power of the upstream CATV signal 80 over a selected time period is required in ingress noise mitigation circuit 100. By almost instantaneously transmitting upstream CATV signal 80 which has a power content that exceeds the predetermined threshold power level, the integrity of the information contained in upstream CATV signal 80 is better preserved.

Once switches 104 and 130 have been moved to the activated position which directly connects the first and second CATV upstream frequency bandpass filters 102 and 134 through conductor 132, switches 104 and 130 are maintained in this activated position for a time determined by one-shot timer 122. When triggered by the logic high signal 120, one-shot timer 122 immediately supplies a logic high output signal 136 to OR gate 124. Either logic high signal 120 or 136 causes OR gate 124 to supply the logic high control signal 126. If the power level of upstream CATV signal 80 falls below the level of threshold signal 114, signal 120 immediately assumes a logic low level. However, one-shot timer 122 will continue to deliver the logic high output signal 136 for the time duration of its internal time constant.

The internal time constant of one-shot timer 122 is equal to the amount of time to transmit a single valid upstream CATV signal packet of the maximum time duration permitted by the signaling protocol, plus a slight additional amount of time to account for inherent tolerances in the components and the timing of one-shot timer 122. In this manner, one-shot timer 122 ensures that switches 104 and 130 assume their activated positions for a long enough time to conduct all single valid upstream signals, including a maximum-length valid upstream CATV signal or packet.

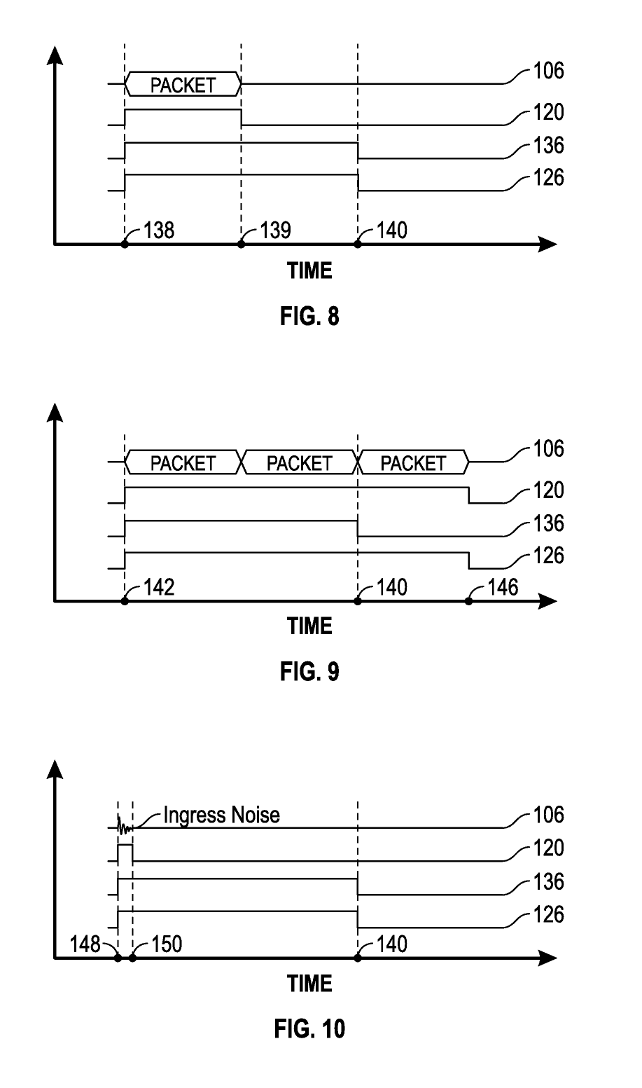

The situation just described is illustrated by the waveform diagrams shown in FIG. 8, taken in connection with FIG. 7. Detection signal 106 represents a single valid upstream CATV signal packet of the permitted maximum time duration whose detection by log amp detector 108 produces logic high trigger signal 120. Signal 120 assumes the logic high level at time point 138, triggering one-shot timer 122 and causing output signal 136 to be asserted at the same time point 138. Control signal 126 from OR gate 124 immediately assumes a logic high level at time point 138. Electronic switches 104 and 130 assume their activated positions for the duration of logic high control signal 126. At time point 139, the maximum time duration of a single valid upstream CTV signal packet or signal ends, and the instantaneous power represented by that signal falls below the threshold power level represented by the threshold signal 114. Signal 120 assumes a logic low level. Since the time constant of one-shot timer 122 is established to slightly exceed the maximum time duration of a single valid upstream CATV packet or signal, logic high signal 136 will continue to time point 140. When signal 136 assumes a logic low level after one-shot timer 122 times out at time point 140, control signal 126 from OR gate 124 simultaneously assumes a logic low level. As a result, control signal 126 is longer in duration than signal 120. When control signal 126 assumes the low logic level at time point 140, electronic switches 104 and 130 assume their normal positions to conduct any upstream CATV signals 80 to termination resistor 103, thereby terminating those signals to ground and preventing the upstream CATV signals 80 from exiting signal conditioning circuit 212 and reaching headend 124.

For multiple valid upstream CATV signal packets which are consecutively transmitted without a substantial time interval separating the multiple sequential upstream packets, one-shot timer 122 will time out before the valid upstream CATV signal transmission terminates. However, the continuous instantaneous power of the multiple sequential valid upstream signal packets will continue to exceed the threshold power level for the duration of the multiple sequential signal packets, thereby causing comparator 112 to continue to assert the logic high trigger signal 120 to OR gate 124 for the duration of the multiple sequential signal packets. The continued application of logic high signal 120 causes OR gate 124 to assert logic high control signal 126 beyond the time when one-shot timer 122 times out. The two upstream CATV upstream frequency bandpass filters 102 and 134 remain connected by switches 104 and 130 in their activated positions, and thereby conduct the multiple sequential upstream CATV signal packets to assure that the full information represented by the multiple sequential signal packets is not truncated or lost by premature termination of those signals. At the termination of such multiple upstream CATV signal packets, the signal power no longer exceeds the threshold signal 114, and the switches 104 and 130 immediately assume their normal positions, thereby preventing any ingress noise from exiting signal conditioning circuit 212 after the longer or multiple sequential valid upstream CATV signal packets have been transmitted.

The situation just described is illustrated by the waveform diagrams shown in FIG. 9, taken in conjunction with FIG. 7. Detection signal 106 represents three, for example, sequential valid upstream CATV packets or signals. Trigger signal 120 assumes the logic high level at time point 142 in response to recognizing the first of the sequential valid upstream packets. One-shot timer 122 is triggered and causes output signal 136 to be asserted at time point 142. Control signal 126 from OR gate 124 also assumes a logic high level at time point 142 in response to the assertion of control signal 136. Electronic switches 104 and 130 assume their activated positions in response to the logic high control signal 126. At time point 140, one-shot timer 122 times out, causing its output signal 136 to assume a logic low level.

However, the instantaneous power level from the multiple sequential upstream signal packets continues to exceed the threshold power level, until the sequence of multiple upstream signal packets terminates at time point 146. So long as signal 120 is at a logic high level, control signal 126 from OR gate 124 causes electronic switches 104 and 130 to remain in the activated position, conducting the multiple sequential valid upstream CATV signal packets through signal conditioning circuit 212 entry port 224, and out cable tap 36 to cable network 20. Once the sequence of multiple valid upstream CATV signal packets has been transmitted, which occurs at time point 146, the absence of any further valid upstream CATV signal packets causes the instantaneous power level to fall below the threshold power level, and signals 120 and 126 assume a logic low level. Electronic switches 104 and 130 respond by assuming their normal positions to prevent the further transmission of upstream CATV signal 80 to the CATV network 20.

If the instantaneous power of ingress noise exceeds the threshold power level, electronic switches 104 and 130 assume their activated positions, as can be understood from FIG. 7. An unusually high and short duration power level of ingress noise can cause this situation. Under that circumstance, trigger signal 120 assumes a logic high level, and one-shot timer 136 is triggered and asserts output signal 136. Electronic switches 104 and 130 assume their activated positions, allowing the ingress noise to pass through upstream filters 102 and 134. Until one-shot timer 122 times out, ingress noise will be allowed to exit signal conditioning circuit 212. The effect of this ingress noise is minimized by the time constant of one-shot timer 122 extending only for the maximum time duration of the longest single valid upstream CATV signal packet permitted under the communication protocol.

The response to ingress noise having instantaneous power that exceeds the threshold is illustrated by the waveform diagrams shown in FIG. 10, taken in connection with FIG. 7. The ingress noise signal is shown as detection signal 106. Because the instantaneous power of the ingress noise exceeds the threshold, a logic high trigger signal 120 is asserted from comparator 112 at time point 148, thereby triggering one-shot timer 122 and causing signal 136 to be asserted at the same time point 148. The logic high signal 136 causes OR gate 124 to assert the logic high control signal 126 at time point 148. Electronic switches 104 and 130 assume their activated positions for the duration of the high level of control signal 126. At time point 150, the instantaneous power from the ingress noise falls below the threshold power level, causing comparator 112 to assert a logic low trigger signal 120. However, one-shot timer 122 has not timed out and continues to deliver the logic high signal 136 for the time duration of its time constant, until time point 140. Control signal 126 from OR gate 124 transitions to a logic low level at time point 140 when one-shot timer 122 times out, causing electronic switches 104 and 130 (FIG. 7) to assume their normal positions. Electronic switch 104 connects termination resistor 103 to terminate any further upstream CATV signals to ground and thereby prevent any further transfer of upstream CATV signals through signal conditioning circuit 212 and cable tap 36, to CATV network 20.

An alternative form 160 of ingress noise mitigation circuit according to the invention is shown in FIG. 11. Ingress Noise mitigation circuit 160 reduces the amount of time that ingress noise may be conducted through cable tap 36 and to CATV network 20 after the initial instantaneous power of the ingress noise is sufficient to exceed the threshold power level, compared to the response of circuit 100 (FIG. 7). Ingress noise mitigation circuit 160 shown in FIG. 11 includes many of the same components as ingress noise mitigation circuit 100 (FIG. 7), and those same components function in the manner previously described.

In response to the instantaneous power of the ingress noise exceeding the threshold power level, represented by signal 114, comparator 112 supplies the logic high trigger signal 120, in the manner previously described. The logic high trigger signal 120 is applied to first one-shot timer 162, to the input terminal of a SPDT RF electronic switch 164, to a second one-shot timer 168, and to the set terminal of a set-reset latch 172. In response to the logic high signal 120, first one-shot timer 162 triggers and supplies output signal 166. Simultaneously, second one-shot timer 168 is triggered and supplies signal 170. Latch 172 is immediately set in response to the logic high trigger signal 120 and supplies control signal 126 to RF electronic switches 104 and 130, causing them to switch to their activated positions and establish the upstream CATV signal communication path for conducting upstream CATV signals through the upstream frequency bandpass filters 102 and 134. In this manner, ingress noise mitigation circuit 160 responds almost instantaneously to the instantaneous power of upstream CATV signal 80 exceeding the threshold to immediately conduct upstream CATV signal 80 through signal conditioning circuit 212 without delay and without the risk of diminishing or losing some of the information contained in upstream CATV signal 80. In this regard, ingress noise mitigation circuit 160 (FIG. 11) is similar in initial response to ingress noise mitigation circuit 100 (FIG. 7). However, ingress noise mitigation circuit 160 has the capability of more quickly closing the upstream communication path through switches 104 and 130 when the upstream communication path was initially established in response to ingress noise.

The rapid closure of the upstream communication path in response to ingress noise is accomplished by integrating signal 120 for a predetermined time established by the time constant of one-shot timer 162. The logic high trigger signal 120 represents the power of the ingress noise exceeding the predetermined threshold power level. Integrating the logic high trigger signal 120 results in a value which represents energy above the threshold power level for the time duration of integration. Integration occurs over the time that signal 166 is asserted by one-shot timer 162. If the amount of power integrated during this time, i.e. energy, is not sufficient to confirm a valid upstream CATV signal with continuous sustained instantaneous power, switches 104 and 130 are moved to their normal positions, thereby terminating the upstream communication path. Since ingress noise generally does not contain significant sustained energy even though an initial burst of the ingress noise may have sufficient instantaneous power to exceed the threshold, the upstream communication path is quickly closed in a typical ingress noise situation.

Integrating the power represented by the threshold power level is accomplished by an integration circuit 179. Integration circuit 179 includes operational amplifier 176. The positive input terminal of operational amplifier 176 is connected to ground reference. A capacitor 178 is connected between the negative input terminal and the output terminal of operational amplifier 176. The negative input terminal of operational amplifier 176 is the input point for signals to integration circuit 179.

Prior to commencement of integration, switch 164 is in its normal position shown in FIG. 11. In the normal position of switch 164, a positive voltage signal 171 is conducted from a power supply source 175 to a resistor 174 which is connected to the negative input terminal of operational amplifier 176. Applying the positive voltage to the negative input terminal of operational amplifier 176 has the effect of causing integration across capacitor 178 to establish an output signal 180 at a voltage level near the ground reference. A voltage level near the ground reference constitutes a logic low signal. Thus, in the normal position of switch 164, output signal 180 from integrator circuit 179 is at a logic low level.

In response to control signal 166 moving switch 164 from its normal position shown in FIG. 11 to its activated position which is the alternate of that position shown in FIG. 11, the logic high trigger signal 120 is applied through resistor 174 to the negative input terminal of operational amplifier 176. So long as trigger signal 120 is at the logic high level, output signal 180 from operational amplifier 176 remains at a logic low level. However, because ingress noise typically has the effect of rapidly subsiding in instantaneous power, the instantaneous power will usually not exceed the threshold for a significant sustained amount of time, thereby causing signal 120 to assume a logic low level during the time that one-shot timer 162 supplies control signal 166. Consequently, with witch 164 in the activated position and signal 120 at a logic low level, operational amplifier 176 integrates this change of input signal level across the capacitor 178, which causes output signal 180 to start increasing from the ground reference level. If the instantaneous power of the ingress noise remains low for a significant portion of the time that one-shot timer 162 asserts control signal 166, as is typical with ingress noise having an initial momentarily-high instantaneous power burst, the voltage across capacitor 178 will increase to a level which corresponds to a logic high level of the signal 180.

The logic high output signal 180 is applied to one input terminal of an AND gate 167. Control signal 166 is applied to another input terminal of AND gate 167. The input terminal to which the control signal 166 is applied is an inverting input terminal, thereby causing AND gate 167 to respond to the inverted logic level of control signal 166. Signal 180 remains at a logic high level for a time period after integration ceases from integration circuit 179, and control signal 166 assumes the logic low level at the end of the integration time established by one-shot timer 162. At that point, AND gate 167 responds to two logic high signals (the logic low signal 166 is inverted at the input terminal), resulting in a logic high level signal 169 applied to OR gate 182. OR gate 182 supplies a logic high level signal 184 to a reset terminal of latch 176. Latch 176 resets, and de-asserts control signal 126 to switches 104 and 130, thereby closing the upstream communication path through CATV upstream frequency bandpass filters 102 and 134. Thus, soon after the initial instantaneous power of the ingress signal diminishes and the integration time set by one-shot timer 162 expires, the upstream communication path is closed to the further conduction of upstream CATV signals, thereby preventing any further ingress noise from entering CATV network 20.

During the time and situation just described, another AND gate 185 has no effect on the functionality. Signal 170 supplied by one-shot timer 168 is asserted for a considerably longer period of time than one-shot timer 162 asserts control signal 166. The time of assertion of signal 170 is the length of time, plus a margin for component tolerances, of the longest single valid upstream CATV packet or signal permitted under the signal communication protocol. The time of integration represented by the assertion of control signal 166 is considerably less than the longest single valid upstream CATV packet. During the integration of the instantaneous power of the ingress noise over the time duration of control signal 166, output signal 170 is at a logic high level, control signal 126 is at a logic high level because latch 172 will have been set by the trigger signal 120, before signal 120 assumes a logic low level after the initial high instantaneous power of the ingress noise has dissipated. The input terminals of AND gate 185 to which signals 120 and 170 are applied are inverting. Thus, under these conditions, AND gate 185 supplies an output signal 187 at a logic low level.

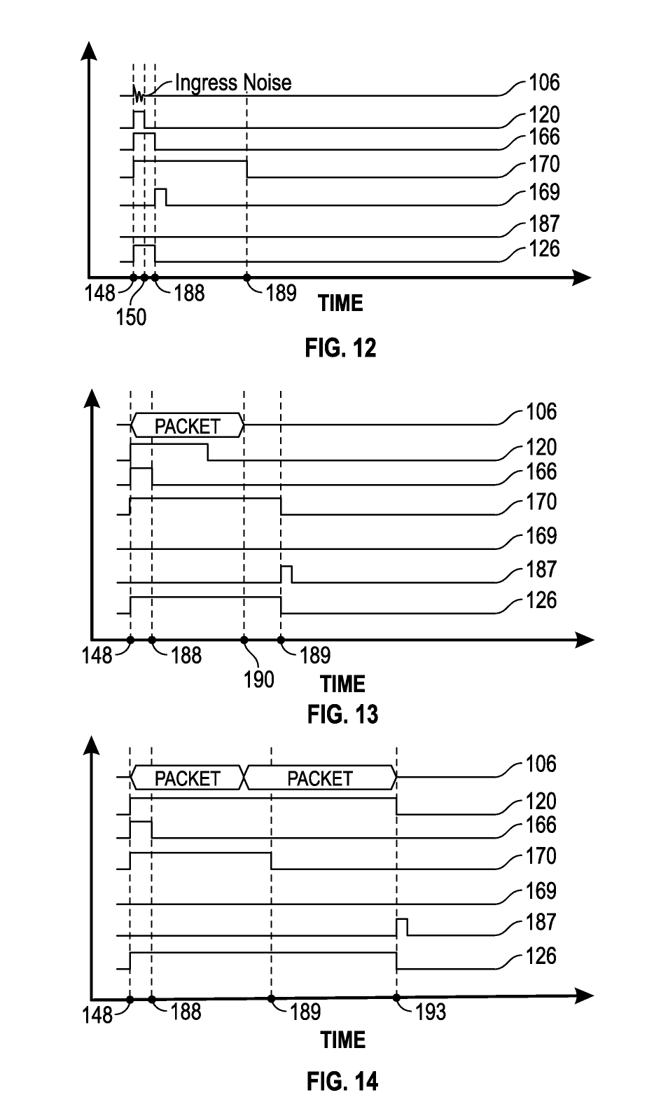

The situation of terminating the upstream communication path created by a burst of ingress noise before expiration of the time duration of a maximum-length valid upstream signal or packet is illustrated by the waveform diagrams shown in FIG. 12, taken in connection with FIG. 11. The ingress noise signal is shown at 106. The instantaneous power of the ingress noise exceeds the threshold power level and causes a logic high trigger signal 120 from comparator 112 at time point 148, thereby triggering one-shot timers 162 and 168 and causing control signals 166 and 170 to be asserted at time point 148. Control signal 126 from latch 172 also assumes a logic high level at time point 148 because the logic high trigger signal 120 sets latch 172. Electronic switches 104 and 130 assume their activated positions for the duration of the logic high control signal 126 to maintain the upstream communication path. At time point 150, the instantaneous power of the ingress noise falls below the threshold power level, and trigger signal 120 assumes a logic low level. However, first one-shot timer 162 has not timed out and continues to deliver control signal 166 until it times out at time point 188. The time duration between time points 148 and 188 is the time constant of one-shot timer 162 which establishes the time duration of integration. The time for integrating a valid upstream CATV signal is the time between time points 148 and 188.

If the integrated value indicates an upstream signal of unsustained instantaneous power, consistent with ingress noise that rapidly dissipates, the resulting logic high signal 180 from integrator 179 is applied to OR gate 182. OR gate 182 supplies logic high signal 180 at time point 188 which, when logically ANDed with the logical inversion of signal 166, causes AND gate 167 to assert signal 169. OR gate 182 responds by asserting a logic high signal 184, which resets latch 172, thereby de-asserting control signal 126. The upstream communication path is terminated when the switches 104 and 130 assume their normal positions.

As is understood from FIG. 12, the upstream communication path remains open from time point 148 to time point 188. This time is considerably less than the maximum time length of a single valid upstream CATV packet or signal, represented by the time between points 148 and 189, or between time points 148 and 150 (FIG. 10). Consequently, even though the upstream communication path is immediately established to allow upstream CATV signal communication whenever the instantaneous power exceeds the threshold, that upstream communication path is closed to further upstream communication very rapidly thereafter if spurious ingress noise established that communication path.

Whenever upstream CATV signal 80 has sustained instantaneous power, noise mitigation circuit 160 assures that upstream CATV signal 80 will be conducted through signal conditioning circuit 212 and to CATV network 20. Such circumstances indicate a valid upstream signal. As understood from FIG. 11, trigger signal 120 is asserted at a logic high level when a valid upstream CATV signal exceeds the threshold. Latch 172 is set and asserts the logic high control signal 126 which moves switches 104 and 132 to their activated positions to establish the upstream communication path. Timers 162 and 168 are triggered, and one-shot timer 162 moves switch 164 to its activated position. Output signal 180 remains at a logic low level during the time of a valid upstream CATV signal 80 while one-shot timer 162 asserts control signal 166 and while the logic high trigger signal 120 remains at a logic high level due to the sustained instantaneous power of the valid upstream CATV signal 80 exceeding the threshold. The logic low signal 180 and the inversion of the logic high signal 166 at the input terminal of AND gate 167 causes AND gate 167 to assert a logic low signal 169, which has no effect on OR gate 182 or latch 172. Thus, during the transmission of a valid upstream CATV signal 80, AND gate 167 has no effect on the status of latch 172.

On the other hand, the time constant of one-shot timer 168 is considerably longer than the time constant of one-shot timer 162. The signal 170 from timer 168 is asserted for the time duration of a single valid maximum-length upstream packet or signal. The logic high level of signal 170 is inverted at the input terminal of AND gate 185. At this time, control signal 126 is at a logic high level because latch 172 has been set. The continuous instantaneous power of the valid upstream CATV signal 80 is represented by a logic high level of trigger signal 120. The logic high level of signal 120 is inverted at AND gate 185. The logic level of the signals applied to AND gate 185 causes it to supply a logic low signal 187, which has no effect on latch 172 during conditions of sustained instantaneous power from the valid upstream signal.

When valid upstream CATV signal 80 terminates, in other words there is no longer valid information in this signal, the logic high level of signal 120 changes to a logic low level. The logic low level signal 120 is inverted at its input terminal to AND gate 185. The logic high signal 170 is still asserted by one-shot timer 168, because timer 168 times the duration of a single valid maximum-length upstream CATV signal. Until one-shot timer 168 de-asserts signal 170, AND gate 185 will not assert a logic high signal 187. However, when signal 170 is de-asserted, AND gate 185 applies logic high signal 187 to OR gate 182. OR gate 182 asserts signal 184 to reset latch 172, and control signal 126 is de-asserted. Switches 104 and 132 move to their normal positions and terminate the upstream communication path through filters 102 and 134.

In response to sustained instantaneous power representative of a valid upstream CATV signal 80, noise mitigation circuit 160 assures that an upstream communication path will be established for the maximum time duration of a single valid upstream CATV signal, provided that there is sufficient instantaneous energy in the upstream CATV signal during the integration time established by signal 166. In this manner, circuit 160 is similar to circuit 100 (FIG. 7) which assures that the upstream communication path remains established for the time duration of a single valid maximum-length upstream CATV signal or packet. However, unlike circuit 100 (FIG. 7), circuit 160 discriminates between short-duration high instantaneous power ingress noise and continuous-duration high instantaneous power upstream CATV signals and rapidly terminates the upstream communication path in response to the former.

The situation of maintaining the upstream communication path in response to sustained instantaneous energy of an upstream CATV signal during the integration time established by the time constant of one-shot timer 162, to allow adequate time for a single valid upstream CATV packet of maximum duration to be transmitted, is illustrated by the waveform diagrams shown in FIG. 13, taken in connection with FIG. 11. Upstream CATV signal 80 is represented by a packet having a time duration less than the maximum allowed time duration for single valid upstream CATV packet as shown at detection signal 106. The instantaneous power of upstream packet 106 exceeds the threshold power level and causes a logic high trigger signal 120 from comparator 112 at time point 148, thereby triggering one-shot timers 162 and 168 and causing control signals 166 and 170 to be asserted at the same time point 148. Control signal 126 from latch 172 also assumes a logic high level at time point 148 due to the assertion of logic high signal 120. Electronic switches 104 and 130 assume their activated positions for the duration of the logic high signal 126 and establish the upstream communication path. At time point 188, first one-shot timer 162 times out and de-asserts control signal 166. The time duration between time points 148 and 188 establishes the time duration of integration.

During the time of integration, the instantaneous power of single packet 106 continuously exceeds the threshold level. Consequently, output signal 180 from integration circuit 179 remains at a logic low level, and the inversion of control signal 166 at AND gate 167 maintains output signal 169 in a logic low level. At time point 188 when one-shot timer 162 times out, control signal 166 assumes a logic low level, but the inversion of that logic low level at input terminal to AND gate 167, coupled with the continuous logic low level signal 180 continues to maintain output signal 169 at a logic low level. The logic low signal 169 does not change for the duration of the situation shown in FIG. 13. As a result, AND gate 167 has no effect on resetting latch 172 in this situation.

During the time between points 148 and 188, logic high control signal 126, logic high trigger signal 120, which is inverted at its input terminal to AND gate 185, and logic high control signal 170, which is also inverted at its input terminal to AND gate 185, cause output signal 187 from AND gate 185 to remain at a logic low level. Therefore, during this time between points 148 and 188, signal 187 from AND gate 185 has no effect on resetting latch 172.

At time point 190 packet 106 terminates. The instantaneous power associated with packet 106 also terminates, causing trigger signal 120 to achieve a logic low level. However, one-shot timer 168 has not yet timed out, so its output signal 170 remains at a logic high level until time point 189. The logic low level trigger signal 120 does not change the state of AND gate 185. Consequently, latch with 172 remains set at time point 190.

When one-shot timer 168 times out, at point 189, control signal 170 assumes a low logic level. The low logic signal 170 is inverted at its input terminal to AND gate 185. Trigger signal 120 previously assumed a logic low level at time point 190. The inversion of signals 120 and 170 at the input terminals to AND gate 185 results in three logic high input signals to AND gate 185, causing the output signal 187 to assume a logic high level. The logic high signal 187 is applied to OR gate 182, and output signal 184 from OR gate resets latch 172. Upon reset, latch 172 de-asserts control signal 126 at time point 189, thereby closing the upstream communication path through filters 102 and 134 as a result of switches 104 and 130 assuming their normal positions.

Thus, as is understood from FIG. 13, a valid upstream CATV signal of any duration will exceed the minimum power threshold measured during the integration time established by one-shot timer 162, and as a consequence, latch 172 will continue to assert control signal 126 and maintain the upstream communication path through filters 102 and 104. The upstream communication path will be maintained for the duration of the time constant of one-shot timer 168, during which its output signal 170 is asserted at a logic high level. By maintaining the upstream communication path during the time that one-shot timer 168 asserts control signal 170, it is assured that all valid upstream CATV signals having a time length at least equal to the maximum length of a single valid upstream CATV signal will pass through the upstream communication path. Consequently, none of the information contained in a single valid upstream packet will be lost or truncated.

The upstream CATV signal communication path remains established during the time between the actual end of the valid upstream CATV signal packet and the end of a maximum-length valid upstream CATV signal packet, represented by the difference in time between points 190 and 189, but that amount of time is relatively short and maintenance of the upstream communication path during this time assures that a valid upstream signal packet of any length up to the maximum length will be transmitted without loss or truncation of any of its information.

In addition to the previously described advantages of quickly closing the upstream communication path after it was established by ingress noise and of establishing the upstream communication path for the maximum length of a valid upstream CATV signal, ingress noise mitigation circuit 160 also has the capability of transmitting multiple sequential valid data packets, without loss or truncation of information. This situation can be understood by reference to FIG. 14, taken in conjunction with FIG. 11.

The first valid upstream packet of the multiple sequence of valid upstream CATV signal packets, shown as 106 in FIG. 14, establishes the upstream communication path due to its sustained instantaneous energy. This energy is sustained during the integration time established by one-shot timer 162. Control signal 166 is asserted at a high logic level until time point 188, and control signal 170 is asserted at a high logic level until time point 189.

The instantaneous power of the sequence of multiple valid upstream CATV packets remains above the threshold level and trigger signal 120 remains asserted at a logic high level for the duration of that sequence of packets until time point 193, when the instantaneous power of the multiple sequential upstream packets terminates. One-shot timer 168 does not time out until time point 189, at which point its output signal 170 assumes a logic low level at time point 189. The low logic level of control signal 170 is inverted at its input terminal to AND gate 185. However, at time point 189, the states of the input signals to AND gate 185 result in AND gate 185 supplying a logic low output signal 187. The logic low output signal 187 has no effect on OR gate 182 and latch 172 remains set.

At time point 193, the instantaneous power of the sequence of multiple valid upstream packets 106 falls below the threshold, causing trigger signal 120 to assume a logic low level. The logic low level of signal 120 at time point 193 is inverted at its input terminal to AND gate 185, causing AND gate to assert a logic high output signal 187. The logic high signal 187 causes OR gate 182 to assert signal 184, thereby resetting latch 172 and de-asserting signal 126. The switches 104 and 130 assume their normal positions, thereby terminating the communication path through upstream signal filters 102 and 134.

In this manner, the upstream communication path is maintained for the duration of the multiple sequential packets, represented by the time between points 148 and 193. However, after the last packet in the multiple sequential series of valid upstream CATV signal packets ends, the upstream communication path is closed to the further transmission of upstream CATV signals, thereby preventing ingress noise from entering CATV network 20.

As has been described in conjunction with FIGS. 11-14, any upstream CATV signal, whether a valid upstream CATV signal or ingress noise, which has sufficient instantaneous power to exceed the threshold will immediately open the upstream communication path through filters 102 and 134. In this sense, ingress noise mitigation circuit 160 does not distinguish between a valid upstream CATV signal and invalid ingress noise which may have sufficient energy to exceed the threshold. Not distinguishing between these signals assures that there is no delay in transmitting valid upstream signals. A delay in transmitting valid upstream CATV signals could lose or truncate part of the information contained in those valid signals. However, once the upstream communication path has been established, the sustained instantaneous power of the upstream signal is integrated during the integration time established by one-shot timer 162, between time points 148 and 188. If the instantaneous power of upstream CATV signal 80 is not sustained, as is the typical case with ingress noise, the upstream communication path is terminated thereafter at time point 188. On the other hand, if the instantaneous power of upstream CATV signal 80 is sustained during the integration time, as is the typical case with a valid upstream CATV signal of any duration, the upstream communication path is maintained for the maximum duration of a single valid upstream signal or packet, represented by the time between points 148 and 189. In this manner, an upstream communication path is assured for the time duration necessary to transmit a single valid upstream CATV signal packet of maximum time duration established by the communication protocol. Again, no loss or truncation of information of any valid upstream CATV signal packet is assured. Similarly, there is no loss or truncation of the information contained in a sequence of multiple valid upstream CATV signal packets, even when the multiple sequential upstream CATV signal packets have a time duration which exceeds the maximum time duration of a single valid upstream CATV signal packet. The upstream communication path remains open for the duration of the multiple sequential upstream CATV signal packets, represented by the time between points 148 and 193. However as soon as the instantaneous power represented by the multiple upstream sequential CATV signal packets falls below the threshold, at time point 193, the upstream communication path is terminated to prevent any ingress noise from exiting signal conditioning circuit 212 and cable tap 36, and entering CATV network 20 at the conclusion of the multiple sequential upstream packets.

The benefit of termination resistors 103 and 190 is their ability to avoid signal reflections, as understood from FIGS. 7 and 11. The proclivity for high-frequency signals to reflect is related to the impedance characteristic of the termination of the conductor which conducts those signals and to the frequency of those signals, as is well known. For this reason, coaxial cables are typically terminated by connecting a terminating impedance between the signal-carrying center conductor and the surrounding reference plane shielding. The terminating impedance value should have a value equal to a characteristic impedance between the signal-carrying conductor and the reference plane shielding, to minimize signal reflections.

The values of termination resistors 103 and 190 are selected to equal the characteristic impedance of the coaxial cables which form drop cables 38 (FIG. 1), and that value is typically 75 ohms. Matching the value of termination resistors 103 and 190 to the characteristic impedance of the coaxial cables minimizes the amount of signal reflection. Reflected signals combine with the incident downstream CATV signals and cancel or degrade the downstream CATV signals. Minimizing the signal reflection maximizes the quality and fidelity of the downstream CATV signals and enhances the quality of service provided from CATV network 20.

As described above, there are numerous advantages and improvements available from the disclosed invention. Upstream noise mitigation circuits 100 and 160, FIGS. 7 and 11, respond to the instantaneous power of upstream CATV signal 80. When the instantaneous power exceeds a predetermined threshold, a signal path for conducting the upstream CATV signal to CATV network 20 and CATV headend 24 is immediately established. Establishing the upstream communication path immediately when the instantaneous power of upstream CATV signal 80 exceeds the threshold substantially reduces or diminishes the risk that information contained in upstream CATV signal 80 will be lost, truncated or diminished. The risk of truncating or losing information in upstream CATV signal 80 is considerably reduced or diminished compared to devices which integrate the power of upstream CATV signal 80 over a time period before establishing the upstream communication path. By responding to the instantaneous power, the information in valid upstream signals is preserved. On the other hand, the ingress noise mitigation circuits 100 and 160 of FIGS. 7 and 11 offer the capability of quickly isolating and terminating the upstream communication path and thereby minimizing the ingress noise entering CATV network 20.

These and other benefits and advantages will become more apparent upon gaining a complete appreciation for the improvements of the present invention. Preferred embodiments of the invention and many of its improvements have been described with a degree of particularity. The description is of preferred examples for implementing the invention, and these preferred descriptions are not intended necessarily to limit the scope of the invention.

1. A cable television (CATV) cable tap device for conducting downstream and upstream CATV signals within a CATV network, the CATV cable tap device comprising:
an entry port;
a through port;
one or more than one tap port;
a signal splitting device having an input terminal and at least two output terminals, wherein the input terminal is electrically connected to the entry port, and a first one of the at least two output terminals is electrically connected to the through port;
a tap signal transmission path, wherein the tap signal transmission path conducts the downstream and the upstream CATV signals between a second one of the at least two output terminals and a first one of the one or more than one tap port; and
a signal conditioning circuit electrically connected along the tap signal transmission path between the second one of the at least two output terminals and the first one of the one or more than one tap port, wherein both the upstream and the downstream CATV signals pass through the signal conditioning circuit along the tap signal transmission path between a signal conditioning circuit input port and a signal conditioning circuit output port, and wherein the signal conditioning circuit blocks transmission of in-home entertainment signals through the signal conditioning circuit.

2. The CATV cable tap device as defined in claim 1, wherein the signal conditioning circuit comprises an in-home entertainment signal frequency rejection filter, wherein both the upstream and the downstream CATV signals pass through the in-home entertainment signal frequency rejection filter, and wherein the in-home entertainment signal frequency rejection filter blocks transmission of in-home entertainment signals through the in-home entertainment signal frequency rejection filter.

3. The CATV cable tap device as defined in claim 2, wherein:
the downstream CATV signals are in a downstream CATV signal frequency band;
the upstream CATV signals are in an upstream CATV signal frequency band, wherein the upstream CATV signal frequency band is different than the downstream CATV signal frequency band; and
the in-home entertainment signals are in an in-home entertainment signal frequency band, wherein the in-home entertainment signal frequency band is different than both the downstream CATV signal frequency band and the upstream CATV signal frequency band.

4. The CATV cable tap device as defined in claim 2, wherein the downstream and the upstream CATV signals pass through the in-home entertainment frequency rejection filter without substantial attenuation.

5. The CATV cable tap device as defined in claim 3, wherein the downstream CATV signal frequency band is a range of frequencies from 54 megahertz to 1002 megahertz, the upstream CATV signal frequency band is a range of frequencies from 5 megahertz to 42 megahertz, and the in-home entertainment signal frequency band is a range of frequencies from 1125 megahertz to 1675 megahertz.

6. The CATV cable tap device as defined in claim 3, wherein the signal conditioning circuit further comprises:
a first branch node electrically coupled to the tap signal transmission path;
a second branch node electrically coupled to the tap signal transmission path;
a downstream CATV signal transmission path, wherein the downstream CATV signal transmission path conducts downstream CATV signals between the first branch node and the second branch node; and
an upstream CATV signal transmission path, wherein the upstream CATV signal transmission path is in parallel electrical connection with the downstream CATV signal transmission path, and wherein the upstream CATV signal transmission path conducts upstream CATV signals between the second branch node and the first branch node.

7. The CATV cable tap device as defined in claim 6, wherein the upstream CATV signal transmission path comprises:
a CATV upstream frequency bandpass filter electrically coupled to the upstream CATV signal transmission path, wherein the CATV upstream frequency bandpass filter passes upstream CATV signals in the upstream CATV signal frequency band and rejects downstream CATV signals in the downstream CATV signal frequency band; and
an ingress noise mitigation circuit electrically coupled to the upstream CATV signal transmission path, wherein the ingress noise mitigation circuit mitigates ingress noise transmission along the upstream CATV signal transmission path.

8. The CATV cable tap device as defined in claim 7, wherein the downstream CATV signal transmission path comprises:
a CATV downstream frequency bandpass filter electrically coupled to the downstream CATV signal transmission path, wherein the CATV downstream frequency bandpass filter rejects upstream CATV signals in the upstream CATV signal frequency band and passes downstream CATV signals in the downstream CATV signal frequency band.

9. The CATV cable tap device as defined in claim 7, wherein the ingress noise mitigation circuit comprises:
a coupler, wherein the coupler divides the upstream CATV signal into a main upstream CATV signal and a detection signal;
a detector, wherein the detector determines the instantaneous level of power of the detection signal; and
a switch, wherein the switch directs the main upstream CATV signal through a termination resistor to a ground when the instantaneous level of power of the detection signal does not reach a predetermined threshold level.

10. A cable television (CATV) cable tap device for conducting downstream and upstream CATV signals within a CATV network, the CATV cable tap device comprising:
a through signal transmission path, wherein the through signal transmission path conducts the downstream and the upstream CATV signals through the cable tap device between an entry port and a through port of the cable tap device;
a signal splitting device coupled to the through signal transmission path between the entry port and the through port;
a tap signal transmission path, wherein the tap signal transmission path branches from the through signal transmission path at the signal splitting device, and wherein the tap signal transmission path conducts the downstream and the upstream CATV signals between the signal splitting device and a tap port of the cable tap device;
a first branch node electrically coupled to the tap signal transmission path;
a second branch node electrically coupled to the tap signal transmission path;
a downstream CATV signal transmission path, wherein the downstream CATV signal transmission path conducts the downstream CATV signals between the first branch node and the second branch node;
a CATV downstream frequency bandpass filter electrically coupled to the downstream CATV signal transmission path; and
an upstream CATV signal transmission path in parallel electrical connection with the downstream CATV signal transmission path between the first branch node and the second branch node, wherein the upstream CATV signal transmission path conducts the upstream CATV signals between the second branch node and the first branch node, and wherein the upstream CATV signal transmission path comprises:
a CATV upstream frequency bandpass filter electrically coupled to the upstream CATV signal transmission path; and
an ingress noise mitigation circuit electrically coupled to the upstream CATV signal transmission path, wherein the ingress noise mitigation circuit mitigates ingress noise transmission along the upstream CATV signal transmission path.

11. The CATV cable tap device of claim 10, wherein the tap signal transmission path further comprises an in-home entertainment signal frequency rejection filter electrically connected to the tap signal transmission path, wherein both the upstream and the downstream CATV signals pass through the in-home entertainment signal frequency rejection filter, and wherein the in-home entertainment signal frequency rejection filter blocks transmission of in-home entertainment signals through the in-home entertainment signal frequency rejection filter.

12. The CATV cable tap device of claim 11, wherein the downstream CATV signal frequency band is a range of frequencies from 54 megahertz to 1002 megahertz, the upstream CATV signal frequency band is a range of frequencies from 5 megahertz to 42 megahertz, and the in-home entertainment signal frequency band is a range of frequencies from 1125 megahertz to 1675 megahertz.

13. The CATV cable tap device of claim 10, wherein the CATV downstream frequency bandpass filter is a first CATV downstream frequency bandpass filter, and wherein the downstream CATV signal transmission path further includes a second CATV downstream frequency bandpass filter.

14. The CATV cable tap device of claim 13, wherein the downstream CATV signal transmission path further comprises an amplifier, wherein the amplifier amplifies the downstream CATV signals.

15. The CATV cable tap device of claim 10, wherein the CATV upstream frequency bandpass filter is a first CATV upstream frequency bandpass filter, and wherein the upstream CATV signal transmission path further includes a second CATV upstream frequency bandpass filter.

16. A method of distributing downstream cable television (CATV) signals in a CATV downstream signal frequency band and upstream CATV signals in a CATV upstream signal frequency band, the method comprising the steps of:
conducting a first portion of the downstream and the upstream CATV signals through a cable tap device between an entry port and a through port;
conducting a second portion of the downstream and the upstream CATV signals through the cable tap device between the entry port and a tap port; and
filtering the second portion of the downstream and the upstream CATV signals through an in-home entertainment signal frequency rejection filter, wherein the in-home entertainment signal frequency rejection filter passes the downstream CATV signals, and wherein the in-home entertainment signal frequency rejection filter passes the upstream CATV signals, and wherein the in-home entertainment signal frequency rejection filter blocks in-home entertainment signals in an in-home entertainment signal frequency band from passing through the in-home entertainment signal frequency rejection filter.

17. The method of claim 16, further comprising the step of splitting the downstream CATV signals in the second portion of the downstream and the upstream CATV signals from the upstream CATV signals in the second portion of the downstream and the upstream CATV signals.

18. The method of claim 17, further comprising the step of preventing the upstream CATV signals in the second portion of the downstream and the upstream CATV signals from reaching the entry port when it is detected that the upstream CATV signals in the second portion of the downstream and the upstream CATV signals comprise noise instead of a valid upstream CATV signal.

19. The method of claim 18, wherein the step of preventing the upstream CATV signals in the second portion of the downstream and the upstream CATV signals from reaching the entry port when it is detected that the upstream CATV signals in the second portion of the downstream and the upstream CATV signals comprise noise instead of a valid upstream CATV signal comprises preventing the upstream CATV signals in the second portion of the downstream and the upstream CATV signals from reaching the entry port when it is detected that an instantaneous level of power of the upstream CATV signals does not exceed a predetermined threshold level of power.

20. The method of claim 18, wherein the step of preventing the upstream CATV signals in the second portion of the downstream and the upstream CATV signals from reaching the entry port when it is detected that the upstream CATV signals in the second portion of the downstream and the upstream CATV signals comprise noise instead of a valid upstream CATV signal comprises the steps of:
dividing the upstream CATV signal into a main upstream CATV signal and a detection signal;
conducting the main upstream CATV signal through a termination resistor to ground when it is detected that an instantaneous level of power of the detection signal is not greater than a predetermined threshold level of power.
